(19) United States
(12) Patent Application Publication
(10) Pub. No.: US 2023/0419406 A1
(43) Pub. Date: Dec. 28, 2023

(54) SYSTEMS AND METHODS FOR PROVIDING A DECENTRALIZED VOLATILITY PLATFORM FOR CRYPTOCURRENCY OPTION TRADING

(71) Applicant: Black Lotus Labs, Inc., New York, NY (US)

(72) Inventors: Lev Gelfer, Brooklyn, NY (US); Sergei Levin, Wallkill, NY (US); Greg Gurevich, Sunny Isles Beach, FL (US); Sergey Shevchuk, Moscos (RU); Boris Shapiro, Brottby (SE)

(21) Appl. No.: 18/199,354

(22) Filed: May 18, 2023

Related U.S. Application Data
(60) Provisional application No. 63/343,401, filed on May 18, 2022.

(51) Int. Cl. G06Q 40/04; G06Q 20/38; G06Q 30/0201

(52) U.S. Cl. CPC G06Q 40/04; G06Q 30/0206; G06Q 20/389

(57) ABSTRACT

A device may upon an option activation via a smart contract, initializing a set of parameters, wherein the smart contract operates on a blockchain network. A device may compute via the smart contract an expected price range for an underlier based on the set of parameters. A device may subdivide via the smart contract the expected price range into a fixed number of standard risk blocks, wherein each respective standard risk block of the fixed number of standard risk blocks includes a price interval centered around a specific value, wherein each standard risk block includes a binary state dependent unit that pays at an expiration of an option lifecycle a fixed amount for a purchased stake if a reference value meets a specific condition, and nothing otherwise. A device may handle via the smart contract a settlement of options via payment of stakes purchased in standard risk blocks.

### CROSS-REFERENCE TO RELATED APPLICATIONS

The present application claims priority to U.S. Provisional App. No. 63/343,401 filed on May 18, 2022, the contents of which are incorporated herein by reference.

### BACKGROUND

Current automated market making (AMM) for cryptocurrency options are not working. Option volumes regularly surpass underlying equity volumes in traditional finance. There is an unmet demand for cryptocurrency options exchanges from speculators, hedge fund managers and entrepreneurs.

In the current structure, independent liquidity providers seeking a yield contribute to a pool similar to the Uniswap company but on a bunch of options. This creates two problems. First, due to the information asymmetry, an option could have a large change in demand leading to a loss for a liquidity provider. Unlike in linear assets, this loss is negatively convex and can be permanent as the options expire. Second, there is liquidity fragmentation. Some options will have more supply from the liquidity providers, while demands might be higher for other options. This will create supply/demand imbalances that are not addressed by the current AMM models. Counteracting these issues is not feasible since one cannot transfer cryptocurrency options from one exchange to another unlike the underlying cryptocurrency assets. This represents a problem rooted in computer technology with respect to how cryptocurrency exchanges and cryptocurrency assets work preventing the current structure form being able to address the problems.

### BRIEF SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed herein are systems, methods, and computer-readable media for providing a new system that addresses the need for institutional and retail options trading in the cryptocurrency markets. The approach disclosed herein has low negative selection per transaction. In other words, the liquidity providers do not get picked off. The approach allows for some liquidity providers to provide liquidity across multiple strikes using the same capital pool.

The disclosed decentralized AMM platform for options solves the convexity payoff problem. This platform allows a dollar from liquidity providers to provide more than a dollar of liquidity. The new structure solves the issues outlined above and makes a distributed options exchange not only possible but better than what currently exists. This approach solves the liquidity fragmentation issue and solves the negative selection and convexity issues in the current market. The approach avoids the necessity of attracting market makers by using AMM. Because it is decentralized and part of a blockchain network, the custody issues are handled on-chain and there is no exchange counterparty risk. ERC20 or Solana compatibility ensures that option terms won't change.

In this approach, a liquidity provider will deposit value such as US dollars or other base currency into an exchange pool. The pool will contain sufficient collateral to cover all possible outcomes across a distribution. In one aspect, extreme tails in the distribution covered by the smart contract are excluded. Through the smart contract, the liquidity provider is exposed equally to all outcomes across all strikes for a given expiration of the option. At the expiration time, the liquidity provider receives the difference between the width of the realized and expected distribution.

The options trader can structure a single option or an option spread and get back the required premium/collateral. The process leverages smart contracts to buy an option or an option spread position. The trader buys or sells calls and puts, or any combination of options, like a participant in the legacy options market. Options combinations are automatically cross-collateralized, adding capital efficiency. At expiration, the trader will receive the difference between the premium/collateral and the option payoff.

The system will connect the liquidity providers and the options traders and transforms the volatility risk into fixed strike options. It is naturally cross-collateralized, granular and spread-friendly. The system operates a smart contract (operating on the blockchain network) that converts pool volatility risk into a complete and granular collection of options ready for trading. The smart contract will keep track of option demand from the trader layer and will account for supply and volatility from the liquidity provider layer. It will utilize the supply/demand data to reprice options and volatility for the system's actors. Further, the system can provide an analytics interface to provide tools for the liquidity providers and options traders.

In some aspects, the techniques described herein relate to a method for trading options, the method including: upon an option activation via a smart contract, initializing a set of parameters, wherein the smart contract operates on a blockchain network including a plurality of distributed compute nodes operating a distributed consensus algorithm that determines when to record transactions on a distributed ledger across the plurality of distributed compute nodes, the transactions being recorded in an immutable manner; computing via the smart contract an expected price range for an underlier based on the set of parameters; subdividing via the smart contract the expected price range into a fixed number of standard risk blocks, wherein each respective standard risk block of the fixed number of standard risk blocks includes a price interval centered around a specific value, wherein each standard risk block includes a binary state dependent unit that pays at an expiration of an option lifecycle a fixed amount for a purchased stake if a reference value meets a specific condition, and nothing otherwise; and handling via the smart contract a settlement of options across all strikes via payment of stakes purchased in standard risk blocks.

In some aspects, the techniques described herein relate to a method of trading options, the method including: providing, from a smart contract to a user interface of a trader device, a tentative price based on all stakes in a set of standard risk blocks being bought, wherein the smart contract operates on a blockchain network including a plurality of distributed compute nodes operating a distributed consensus algorithm that determines when to record transactions on a distributed ledger across the plurality of distributed compute nodes, the transactions being recorded in an immutable manner; receiving, at a smart contract, a trading order from a trader via the user interface; converting the trading order into stakes in one or more standard risk blocks of a set of standard risk blocks; executing the trading order until an option expiration occurs at an expiration time; identifying a winning standard risk block from the set of standard risk blocks, the winning standard risk block containing a value of an underlier at the expiration time; and settling the trading order by having a liquidity pool pay a fixed amount (lotsize) for each stake purchased in the winning standard risk block.

In some aspects, the techniques described herein relate to a system including: at least one processor; and a computer-readable storage medium storing instructions which, when executed by the at least one processor, causes the at least one processor to perform operations including: upon an option activation via a smart contract, initializing a set of parameters, wherein the smart contract operates on a blockchain network including a plurality of distributed compute nodes operating a distributed consensus algorithm that determines when to record transactions on a distributed ledger across the plurality of distributed compute nodes, the transactions being recorded in an immutable manner; computing via the smart contract an expected price range for an underlier based on the set of parameters; subdividing via the smart contract the expected price range into a fixed number of standard risk blocks, wherein each respective standard risk block of the fixed number of standard risk blocks includes a price interval centered around a specific value, wherein each standard risk block includes a binary state dependent unit that pays at an expiration of an option lifecycle a fixed amount (lotsize) for a purchased stake if a reference value meets a specific condition, and nothing otherwise; and handling via the smart contract a settlement of options via payment of stakes purchased in standard risk blocks.

In some aspects, the techniques described herein relate to a system including: at least one processor; and a computer-readable storage medium storing instructions which, when executed by the at least one processor, causes the at least one processor to perform operations including: providing, from a smart contract to a user interface of a trader device, a tentative price based on all stakes in a set of standard risk blocks being bought, wherein the smart contract operates on a blockchain network including a plurality of distributed compute nodes operating a distributed consensus algorithm that determines when to record transactions on a distributed ledger across the plurality of distributed compute nodes, the transactions being recorded in an immutable manner; receiving, at a smart contract, a trading order from a trader via the user interface; converting the trading order into stakes in one or more standard risk blocks of a set of standard risk blocks; executing the trading order until an option expiration occurs at an expiration time; identifying a winning standard risk block from the set of standard risk blocks, the winning standard risk block containing a value of an underlier at the expiration time; and settling the trading order by having a liquidity pool pay a lotsize amount for each stake purchased in the winning standard risk block.

This brief introduction is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim. The foregoing, together with other features and embodiments, will become more apparent upon referring to the following specification, claims, and accompanying drawings.

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates the basic system according to an aspect of this disclosure;

FIG. 2 illustrates an option branch according to an aspect of this disclosure;

FIG. 3 illustrates two option branches with different initialization schedules according to an aspect of this disclosure;

FIG. 4 illustrates an option lifecycle across strikes according to an aspect of this disclosure;

FIG. 5 illustrates an expected price range according to an aspect of this disclosure;

FIG. 6 illustrates a standard risk block construction according to an aspect of this disclosure;

FIG. 7 illustrates scales for price intervals and strikes according to an aspect of this disclosure;

FIG. 8 illustrates a standard risk block construction according to an aspect of this disclosure;

FIG. 9 illustrates another standard risk block construction according to an aspect of this disclosure;

FIG. 10 illustrates another standard risk block construction according to an aspect of this disclosure;

FIG. 11 illustrates another standard risk block construction according to an aspect of this disclosure;

FIG. 12 illustrates standard risk block width according to an aspect of this disclosure;

FIG. 13 illustrates another standard risk block widths according to an aspect of this disclosure;

FIG. 14 illustrates a determination of a winning block according to an aspect of this disclosure;

FIG. 15 illustrates a distribution range according to an aspect of this disclosure;

FIG. 16 illustrates replicating call option payoff with stakes in standard risk blocks according to an aspect of this disclosure;

FIG. 17 illustrates call option payoff via standard risk blocks according to an aspect of this disclosure;

FIG. 18 illustrates buying and selling options from the viewpoint of the trader according to an aspect of this disclosure;

FIG. 19 illustrates buying and selling options via a standard risk block system according to an aspect of this disclosure;

FIG. 20 illustrates a determination of a winning standard risk block according to an aspect of this disclosure;

FIG. 21 illustrates a settlement process from a trade experience according to an aspect of this disclosure;

FIG. 22 illustrates a settlement according to a standard risk block system according to an aspect of this disclosure;

FIG. 23 illustrates how a liquidity provider contributes a base currency to the liquidity pool according to an aspect of this disclosure;

FIG. 24 illustrates how a liquidity provider withdraws base currency from the liquidity pool according to an aspect of this disclosure;

FIG. 25 illustrates an example standard risk block system according to an aspect of this disclosure;

FIG. 26 illustrates an example determination of winning standard risk block according to an aspect of this disclosure;

FIG. 27 illustrates an example determination of winning standard risk block according to an aspect of this disclosure;

FIG. 28 illustrates a method embodiment;

FIG. 29 illustrates another method embodiment; and

FIG. 30 illustrates an example computing device in accordance with various embodiments.

### DETAILED DESCRIPTION

The protocol disclosed herein is a decentralized Automated Market Maker (AMM) that provides optimized liquidity, greater pre-trade capital efficiency, protection from negative selection, and full collateralization with zero counterparty risk for options trading. The long-term mission is to fully realize the promise of cryptocurrency by helping to develop the risk management system for Web 3.0 with on-chain price discovery and transparency on risk. What Bitcoin did for permissionless value transfer, this disclosure strives to do for risk transfer.

The approach in this disclosure addresses current computer-based issues with cryptocurrencies and introduces a computer-based solution. To this extent, the disclosed approach does not represent merely the implementation of previously existing business practices on a generic computer system. The use of a blockchain network with its distributed nodes, distributed consensus algorithm, and distributed ledger, represents hardware and software details beyond a generic computer processor and involve implementing a system that represents a practical application that solves a problem rooted in computer technology. These additional hardware features are similar in nature to a claim that would include a printer having a belt, roller, printhead and ink cartridge. Such as patent claim would not recite an abstract idea under the Alice decision, even if other parts of the claim included a computer processor or involved an abstract idea. Thus, when a claim includes a printer is not an abstract idea, then a claim that includes a blockchain network (with all the details outlined above), also would not recite an abstract idea even if the claim did include a computer processor.

Based on the system, pricing AMM that permits trading backed by liquidity pools designed to cover all potential payoffs, and subject to smart contracts and the underlying blockchain operating as intended.

Traditional financial markets are fundamentally vulnerable. They involve high counterparty risk and trust requirements. Markets are inherently subject to boom-bust dynamics and instability during liquidation cycles. Markets rely on central authorities to regulate risk-taking of too-big-to-fail entities and act as lender of last resort. Over the past several decades, these vulnerabilities have created systemic risks, with liquidations and bankruptcies at many large organizations including LTCM, Lehman, AIG, Merrill Lynch, Archegos, the Central Bank of Lebanon, the global nickel market, and the recent Bank of England Gilt bailout.

Digital markets are not exempt from similar dynamics. The cryptocurrency winter of 2022 has shown that bad actors continue to exist, and their failures have a destabilizing effect on the entire industry. Many funds, startups and even established companies in the digital asset space have recently failed due to high leverage, lack of transparency into balance sheets and lending practices, and improper and opaque risk management. Unsurprisingly, replicating flawed models results in poor outcomes well known in traditional finance, such as liquidity spirals and bank runs—but without any of the protections. In its current state the cryptocurrency industry has all of the problems of traditional finance without any of the protections afforded by a government acting as a lender of last resort via a central bank bailout.

Such vulnerabilities stress the necessity for a financial system that is fully on-chain, transparent, and truly decentralized. These capabilities are made possible through the blockchain network structure. These shortcomings also underscore the need to leverage the expertise of experienced Traditional Finance (TradFi) veterans to avoid running into the same problems that cryptocurrency was designed to solve in the first place. The cryptocurrency ecosystem can use protection from two key risks: (1) High volatility triggered by liquidity crunches and bank run dynamics, which can destabilize the entire market through redemptions and collateral drawdowns and (2) Counterparty risk due to under-collateralization and lack of transparency. Setting transparent and appropriate collateral requirements is at the core of ensuring protocol solvency.

There is a cryptocurrency option market demand. There is growing interest and trade volume in cryptocurrency options. According to The Block Research, the combined trading volume of Bitcoin (BTC) and Ether (ETH) options increased 443% in 2021. After peaking at $14 bn in October 2021, aggregated open interest of Bitcoin options now stands at approximately $5 bn in October 2022. This indicates an unmet demand (from speculators, hedgers, entrepreneurs, etc.) for cryptocurrency option trading with sufficient liquidity depth. It is expected that cryptocurrency options volume could ultimately surpass underlying product volume as is currently the case for US listed equities. According to CBOE Global Markets data, the average daily notional value of traded single-stock options has recently risen to more than $450 bn, compared with about $405 bn for stocks.

This disclosure solves the AMM dilemma for options. The promise behind the nascent Decentralized Finance (DeFi) ecosystem is that blockchain technology can help replace centralized financial intermediaries (middlemen) with middleware. The value of assets stored in the DeFi ecosystem exploded from less than $1 bn at the start of 2020 to more than $200 bn in early 2022, before retreating to $53 bn total value locked in DeFi protocols as of October 2022. Automated Market Makers (AMMs) are algorithmic agents that provide liquidity in electronic markets. Decentralized exchanges (DEXs) relying on AMMs are quickly becoming the leading exchanges in DeFi for cryptocurrency spot trading. Unlike centralized exchanges (CEXs) that provide custody services for users' funds, DEXs are peer-to-peer marketplaces facilitated through smart contracts that eliminate the need for an intermediary or custodian. The DEX to CEX spot trade volume (as a %) rose from 0% in January 2019 to a peak of 17% in January 2022, and as of February 2023 stands at 6.43%. One popular model is the “constant product” AMM (e.g., Uniswap and SushiSwap), which sets the exchange rate between two assets on the basis of the relative size of the reserves for the two assets being exchanged, ensuring that the product of the quantities of each asset in the pool are equal to a constant.

However, to date the promise of the nascent DeFi ecosystem to leverage blockchain technology and replace centralized financial intermediaries with DEXs has not been realized for options trading. As opposed to the hundreds of cryptocurrency spot exchanges, there is currently just one retail-focused CEX that accounts for over 90% of options market volume. Further, even the most successful DEX options platforms still operate as options marketplaces and clearing houses, with order matching systems and order books similar to centralized exchanges. The inventors do not believe this is the right approach for DeFi. While such DEXs may eliminate the need for an intermediary or custodian, without a strong market maker presence the market trades by appointment only and has no liquidity in terms of quotes or depth. This model for market making has shortcomings, some of which have the potential to be mitigated by an AMM with decentralized liquidity provisioning and deterministic pricing (of the sort pioneered by Uniswap for spot trading). Further, order book mechanisms are challenging to use within a smart contract environment, where latency introduced by a decentralized system increases pickoff risk.

For these reasons, an AMM with decentralized liquidity provisioning and deterministic pricing (of the sort pioneered by Uniswap for spot trading) is the best approach for DeFi options and the entire DeFi ecosystem in general. The right AMM has the potential to reduce price manipulation (provided liquidity pools are large enough), protect liquidity takers from negative selection and from being picked off, and improve overall liquidity conditions while allowing anyone to passively earn yield from providing capital to support market making. However, the constant product approach does not work for non-linear assets such as options. This can be characterized as the AMM dilemma. No person to date has designed and implemented the right AMM for options. The innovation of the disclosed system, which differs from the constant function AMM offered for spot, solves the AMM dilemma for options.

There are limitations of order books and order matching. With order books and order matching, market liquidity is provided by market makers (also known as dealers). Generally, this model for market making has a number of key shortcomings: (1) All market players face the possibility of being taken advantage of by more informed participants. This is known as pickoff risk, i.e., the risk associated with negative selection due to information asymmetry. Market makers are also exposed to pickoff risk; risk and return to the market maker is implicit in the bid-ask spread; (2) There is an unequal informational playing field. Market making requires investments in costly data subscription services, with a high update frequency, to get superior knowledge of order flow in real time; (3) Retail traders face negative selection. Retail traders are likely to be picked off and see their limit orders executed only when they are on the wrong side of the trade. Ultimately, market makers have the full discretion to execute, or not execute, a trader's limit order. This problem is particularly acute for the options market. Though committed to dynamically updating bid and ask quotes, option dealers can cancel a whole listed option chain at once if the price of the underlying moves unfavorably for them; (4) There is potential for price manipulation. When volume is low, large limit orders can destabilize the market and lead market makers to revise bid-ask prices, even if they are subsequently canceled before they have had a chance to be executed; (5) Liquidity is there, until it's not. Ultimately, liquidity dries up when it is needed the most. This happens when there is high volatility and uncertainty in the marketplace, and market makers are most afraid of negative selection and unwilling and/or unable to take on inventory positions.

When it comes to options specifically, as opposed to other financial assets, liquidity is particularly challenging. Options have a large number of defining instrument features (e.g. underlying, maturity, strike price), making it more difficult for traders to serve as direct counterparts. The market only clears if a set of orders spanning the totality of defining instrument features can be matched, resulting in many options (by month or strike) trading infrequently unless there is a strong market making presence. Without deep liquidity, large orders are likely to suffer from “slippage”, that is buyers paying above-market prices. Dealers' willingness to take positions—long or short—is ultimately limited by their capital and ability to absorb risk.

There are benefits of AMMs. As mentioned, AMMs with liquidity provision models that rely on crowdsourced pools of cryptocurrencies or tokens locked in a smart contract to facilitate trades are quickly becoming a dominant model in the DeFi ecosystem through a number of innovative protocols, such as the constant product AMM. Such AMMs potentially mitigate some of the above-mentioned shortcomings:

The first shortcoming is mitigated because the risk and return associated with market making is made explicit, rather than implicit in the bid-ask spread. Liquidity providers are subject to the following risk/return profile: (1) The return for providing liquidity is a share of trading fees for trades that they support; and (2) There is exposure to a risk of impermanent loss (e.g. for constant product AMMs) when the price of deposited assets changes as compared to when they were deposited. Further, though liquidity providers are still potentially exposed to pickoff risk (“toxic flow”, which no AMM can ever completely eliminate), the adverse impact of negative selection is “mutualized” and shared equally by liquidity providers. Anyone who puts up capital to support market making by contributing to a liquidity pool at the same time is exposed to the same risk/return profile.

Another shortcoming is mitigated by having an equal informational playing field. All information that is on-chain is simultaneously available to market participants. As such, market making no longer requires significant investments in data and infrastructure to get visibility of the order flow in real time.

Another shortcoming is mitigated by the fact that liquidity takers do not face negative selection. They are guaranteed a size for their trade. The price is deterministic and depends on the relative size of token reserves and the size of the order.

Another shortcoming is mitigated by the fact that AMMs are naturally tamper-resistant, provided the pool is large enough. The ability of large orders to impact price is dependent on the size of the order relative to the liquidity pool (and the relative sizes of token reserves in the pool), rather than volume.

A final shortcoming is mitigated by through an expected reduction in the volatility of liquidity conditions. With constant-product AMMs, the price asymptotically tends to infinity as one token reserve decreases relative to the other, making the removal of all liquidity impossible as long as liquidity providers don't withdraw from the pool. The sharing of risk across all liquidity providers (and specifically the fact that the adverse impact of negative selection is mutualized) reduces incentives to withdraw.

There is an AMM dilemma for options as noted above. Though it is conceivably possible to apply a fixed constant-based approach to create an AMM for options, with independent liquidity providers seeking yield and contributing to a liquidity pool on a variety of options, such protocols have failed to attract users or volume. This is due to two obvious problems (the AMM dilemma for options): Problem 1: Negative selection due to the information asymmetry. The constant product model is not well suited to non-linear assets. Changes in demand can lead to losses that are negatively convex and can become permanent for liquidity providers as options expire. Problem 2: Liquidity fragmentation and supply/demand imbalances. Some options will have high liquidity supply from liquidity providers and low demand from traders. Others will have low liquidity supply from liquidity providers and high demand from traders. This will create supply/demand imbalances that are not addressed by the current AMM models. Counteracting these is not feasible since one cannot transfer cryptocurrency options from one exchange to another, unlike the underlying cryptocurrency assets.

Pricing of conventional options is typically based on the Black-Scholes model and its modifications. There have been several attempts to use Black-Scholes volatility as an underlying asset for AMM as opposed to using options themselves, but this in turn creates two problems. Problem 1: Since implied volatility is generally not a tradable asset, it is hard to create an indifference curve for it in the way that can be done for other assets traded on AMMs that use a fixed constant-based approach to market-making. Problem 2: Retail investors do not trade volatility products such as VIX, so volumes will be low.

The breakthrough idea of the present inventors came with the realization that in order for an AMM to allow for organic on-chain option pricing to take place, a new fundamental way of looking at risk is needed by decomposing it into small fungible units. The disclosed protocol is an AMM for options trading that solves the AMM dilemma for options via: (1) a novel pricing methodology that relies on binary state-contingent payout units (standard risk blocks) and (2) an automated joint liquidity provision structure across all strikes to reduce negative selection for liquidity providers. Note that this approach differs from prior approaches related to risk management in which known existing business processes are simply implemented on a generic computer system. Such is not the case with respect to the current disclosure since it introduces a new way of even evaluating and treating risk by decomposing it into small fungible units.

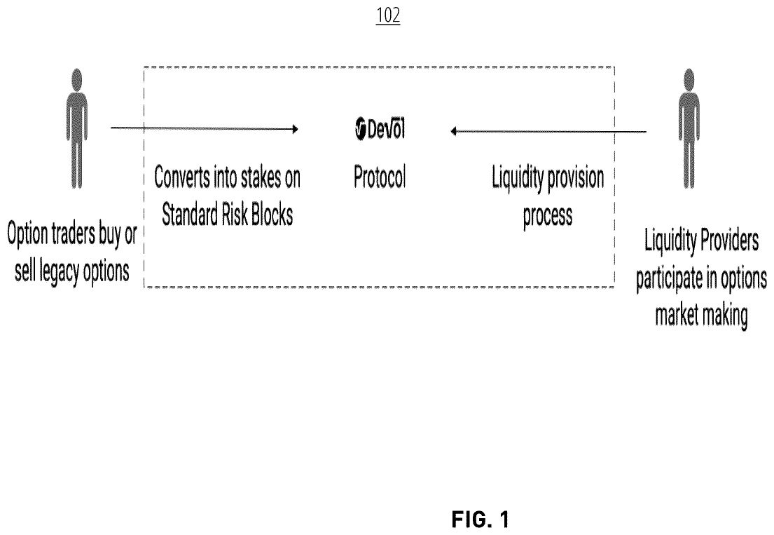

The disclosed protocol is a proprietary decentralized protocol currently built on Solana smart contracts. Other types of smart contracts can apply as well on any blockchain network. An application programming interface (API) can be made available to the public. Option traders and liquidity providers can connect to the protocol via the platform's user interface 102 shown in FIG. 1. Traders buy or sell traditional calls and puts, or any combination thereof, like participants in the legacy options market. Their user experience is similar to any other professional option trading platform. However, all orders are translated into a collection of stakes bought or sold in individual standard risk blocks. Liquidity providers contribute base currency into liquidity pools and have an opportunity to generate yield for providing capital to support market making without actively trading options. Capital for market-making is decentralized, allowing for the “democratization” of market-making. All trades are peer-to-pool; that is, the liquidity pool takes the opposite exposure of all traders' order.

The disclosed protocol reinvents options trading with a number of features: First is the feature of settlement in a base currency. All options that can be traded via the protocol are European options settled in cryptocurrency (initially, a stablecoin like USDT or USDC), what can be called the base currency. Options are defined for a specific underlying (e.g. BTC) and base currency (e.g. USDC for USDC-settled options)—together a “trading pair”. The inventors make no representation as to whether stablecoins used as base currency will keep their peg to fiat. Currently, the trading pairs on the platform are BTC/USDT, ETH/USDT, with plans to add BTC/USDC and ETH/USDC. Other trading pairs can be used as well and these are just examples.

Another feature is how standard risk blocks are used. Options are decomposed into a series of elementary, state contingent payout units called a “standard risk block”. Each standard risk block can be thought of as an individual unit that will pay a fixed amount for each stake bought by a trader but only in a certain state of the world—that is, if at maturity the price of the underlier falls within a specific price range (an interval centered around the block's central strike price). This approach is inspired by the fundamental ideas of K.J. Arrow and G. Debreu, namely the so-called “Arrow Debreu securities” used in general equilibrium theory. In terms of securities traded in traditional markets, they would be most analogous to digital options. These units are individual building blocks that can be assembled to create any option strategy payoff, and more generally any customizable payoff structure. Their linear combinations can approximate with good precision the payoff of any options occurring in traditional markets, including the standard call and put, as well as more complex multi-legged instruments.

On-chain price discovery via AMM is discussed next. Options are priced on the basis of stakes bought in each standard risk block. The AMM utilizes supply/demand data to continually reprice blocks individually, determining the (dynamic) price of a stake in a given standard risk block on the basis of: (1) The impact of the purported trade on the overall liquidity conditions, dependent on the size of the liquidity pool and its sufficiency for payoff in case the standard risk block wins; and (2) The impact of the purported trade on the inventory risk given all other existing positions, so as to ensure the defense of liquidity providers in case of rapid price movement of the underlier.

Full collateralization is discussed next. Options are fully collateralized with base currency locked in liquidity pools set up to support options across all strikes for a specific expiration and for a given trading pair. The pricing AMM guarantees that option premia and collateral deposited by traders (for option buyers and sellers, respectively), combined with funds in the liquidity pool, are sufficient to cover the highest possible option payoff for all option strikes for a given expiration—that is, the maximum potential payment owed by the standard risk block system on account of all stakes that have been purchased by traders. In order to make this capital-efficient and still generate yields for liquidity providers, the approach disclosed does not span unrealistic parts of the distribution. Options on the system are only defined over a specific expected price range for the underlier that excludes extreme distributional tails. Liquidity pools are only designed to cover option payoff over an expected price range for the underlier that contains at least 3 standard deviations of the underlier during the option trading period. This still covers over 99% of the distribution for the underlier. Counterparty risk is the risk that option buyers may not receive their full option payoff. Subject to smart contracts and the underlying blockchain operating as intended, this approach eliminates counterparty risk due to improper collateralization. That is to say, the approach replaces the risk of liabilities not being met due to a counterparty's management of their balance sheet resulting in insufficient or illiquid collateral with pure technology risk. Counterparty risk is particularly acute for options vs. spot markets because settlement is in the future.

A liquidity provision structure is discussed next. Liquidity providers deposit funds in a liquidity pool to support market making without having to pick specific strikes or engage in active options trading—they just need to choose a given trading pair and expiration. Each liquidity pool is assigned to a specific trading pair and time to expiration across all strikes. Note that a liquidity pool only supports one actively traded expiration at a time. After settlement, funds are rolled-over into a new liquidity pool to support the next option to be initialized (across strikes) in the same chain. During trading, the liquidity pool buys or sells options as needed to meet traders' needs, i.e., taking the opposite side of traders' transactions with respect to all strikes. This protects liquidity providers from being picked off at certain strikes.

It is not possible to predict the actual yield of a given liquidity pool for a given trading period. This ultimately depends on (1) trader activity and the pool's aggregate exposure, (2) the difference between realized and implied volatility, and (3) the performance of the underlier. There is no guarantee that liquidity providers will get a positive yield. Indeed, it is also not possible to guarantee the absence of toxic flow. As compensation for providing liquidity to the market, liquidity providers collect a portion of the transaction fees paid by traders, 50% or more. Liquidity providers benefit from transaction volume and their interests are aligned with the interests of the platform—to create an active and liquid trading marketplace.

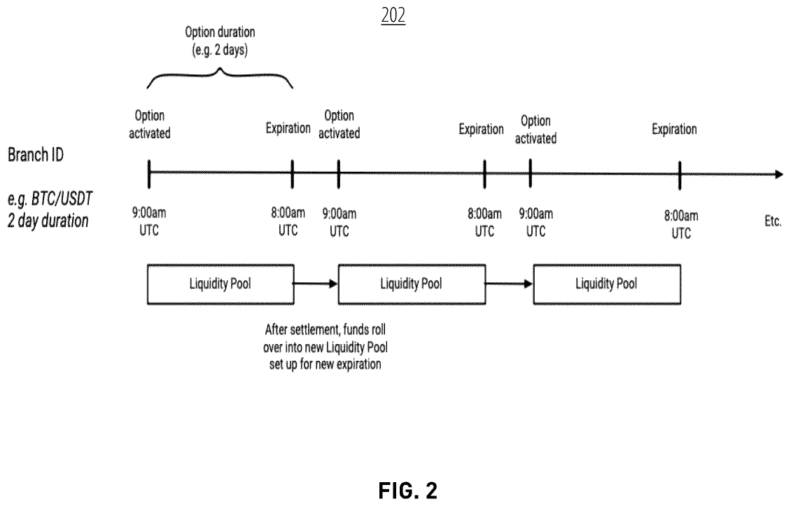

FIG. 2 illustrates an aspect of the subject matter in accordance with one embodiment. FIG. 2 illustrates an option branch 202. The following is an option lifecycle overview. Note that the term “option” is used loosely to describe the entire range of strikes over which market making will happen. This is because all strikes for a given expiration and trading pair are initialized at the same time through the formation of the standard block system and are backed by the same liquidity pool.

The process for initializing options is managed via branches that are run by workers (computer resources capable of carrying out certain tasks). A branch is a chain of options (all strikes) scheduled to be initialized with periodic frequency for a given underlying asset and option duration (maturity), with each expiration backed by a specific liquidity pool as shown in FIG. 2.

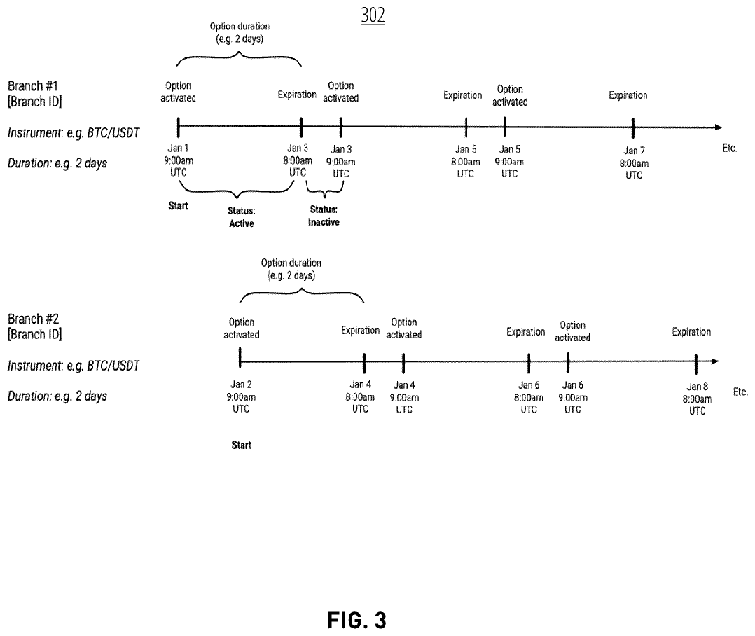

Two option chains may have the same trading pair and option duration, but a different initialization schedule. FIG. 3 illustrates this approach as feature 302. For example, an option for the trading pair BTC/USDC with a two-day maturity could be activated January 1,3,5, etc. in one branch and January 2, 4, 6, etc., in another.

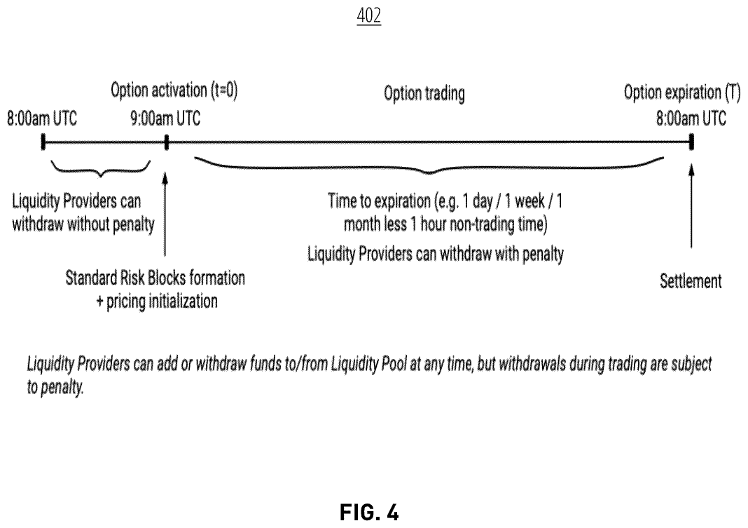

FIG. 4 illustrates how the process 402 for trading options from the time of initialization to settlement (option lifecycle) is automated. Overall, there are three major phases during the option lifecycle: (1) Option activation. Options are activated at 9:00 am UTC. Initial parameters for the option are set (including base currency, underlying, maturity). Standard risk blocks are initialized. (2) Option trading and market discovery. Market participants buy and sell options via stakes bought and sold in standard risk blocks, which are dynamically priced to reflect supply and demand and the sufficiency of the liquidity pool for option payoff. (3) Option expiration and settlement process. Options expire, for example, at 8:00 am UTC. The winning standard risk block is identified, and traders who bought stakes in the winning block receive the option payoff. Funds in the liquidity pool serve as collateral for the payoff.

Option activation is discussed next. Whenever an option is initialized, an administrator sets the relevant parameters for the option specification (See Table 1). Options are strictly defined over a specific price interval [xmin, xmax] that contains most ordinary price fluctuations of the cryptocurrency underlier until option expiration—in fact, allowing for at least three and up to six standard deviations during the trading period. This covers over 99% of the probability distribution.

The distribution of the underlier price at option expiration is assumed to be lognormal. The center of the distribution M (middle of the distribution) is the current price (spot) of the underlier at the time the option is initialized. The standard deviation (a) is derived from the implied volatility of options from most recent expirations on the same underlier. Implied volatility is computed and displayed on the platform on the basis of the Black-Scholes model (using weighted strikes, like a VIX formula) over the period to expiration (e.g., two days, or some other interval depending on the option maturity). It then gets normalized and displayed as an annualized number, multiplying by time or a mathematical operation on time like the square root of time.

TABLE 1
Relevant Parameters

| | |
|---|---|
| Underlier: | Underlying cryptocurrency token |
| Activation date | Date that the trading will start |
| (t): | |
| Expiration date | Date that the option expires |
| (T): | |
| Expected price | Minimal and maximal values that are |
| range for the | expected for the underlier price at expiration, |
| underlier | excluding extreme distributional tails |
| (xmin, xmax): | |
| Accuracy of | Number of decimal places |
| calculation: | |
| width factor: | Parameter (e.g. 1,2,3, . . . ) that sets the number |
| | of standard de-viations to the right and to the |
| | left of the center of the distribution to be |
| | covered by the Standard Risk Block system |
| width parameter | Parameter used to determine the width of |
| γ: | standard risk blocks |

The assumption of lognormality in underlying prices is a rough approximation. Studies exist showing that cryptocurrency return distributions may be fat-tailed, that is, returns exhibit more frequent and larger extreme (tail) returns than a lognormal model would predict. In later version of the protocol, this assumption will be tested empirically against historical data. It may turn out that an empirical distribution will work better for helping convert options into standard risk blocks and determining the adequacy of the liquidity pool.

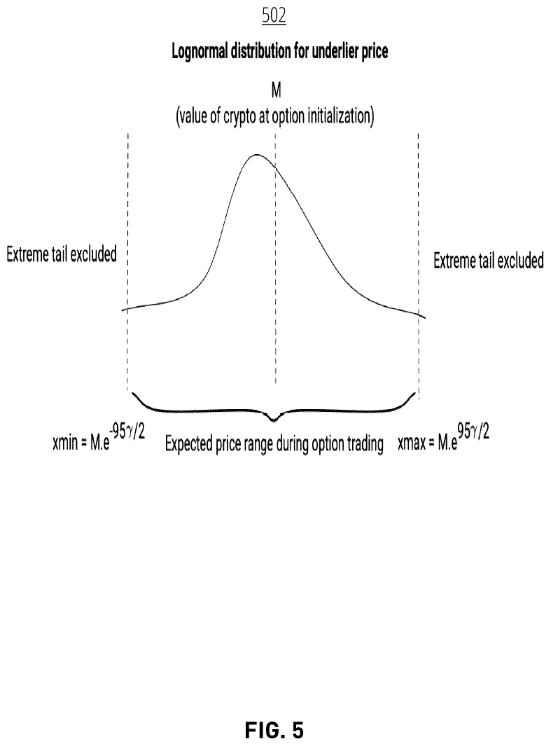

An expected range is discussed next with reference to the feature 502 of FIG. 5. The width factor is a parameter (e.g. 1, 2, 3, . . . ) that sets the number of standard deviations (to the right and to the left of the center of the distribution) to be covered by the standard risk block system. This parameter is set by the administrator to ensure that enough of the distribution is covered. The smart contract then computes the width parameter γ on the basis of implied volatility and the width factor:

$$γ = \frac{σ \times width factor}{47}$$

The lowest and highest expected value for the underlier are xmin=M×exp(−95γ/2) and xmax=M×exp(95γ/2) respectively. Any payoff of the winning standard risk block, and therefore any option payoff, is capped on the basis of the underlying cryptocurrency staying within this range and not dropping below or exceeding its lowest or highest expected values. The bigger implied volatility, the width factor and the price of the underlier at the time of option initialization, the bigger the expected range.

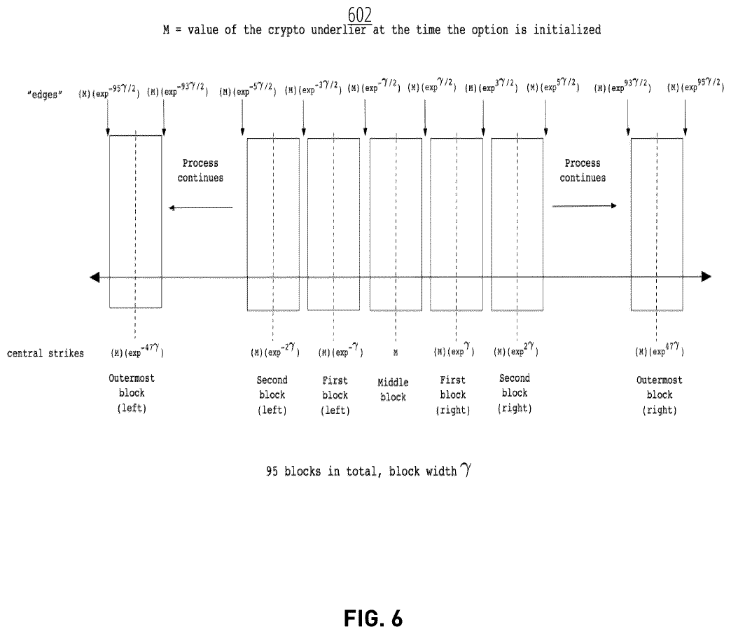

Standard risk block construction is discussed next with reference to FIG. 6. At the time the option is initialized, the smart contract subdivides the expected price range of the underlier into a fixed number of standard risk blocks (currently 95 on Solana). The smart contract builds standard risk blocks from the initial lognormal distribution of the underlier price at option expiration. Each standard risk block's price interval is centered around a specific central strike price. See FIG. 6 for all central strikes and price intervals 602.

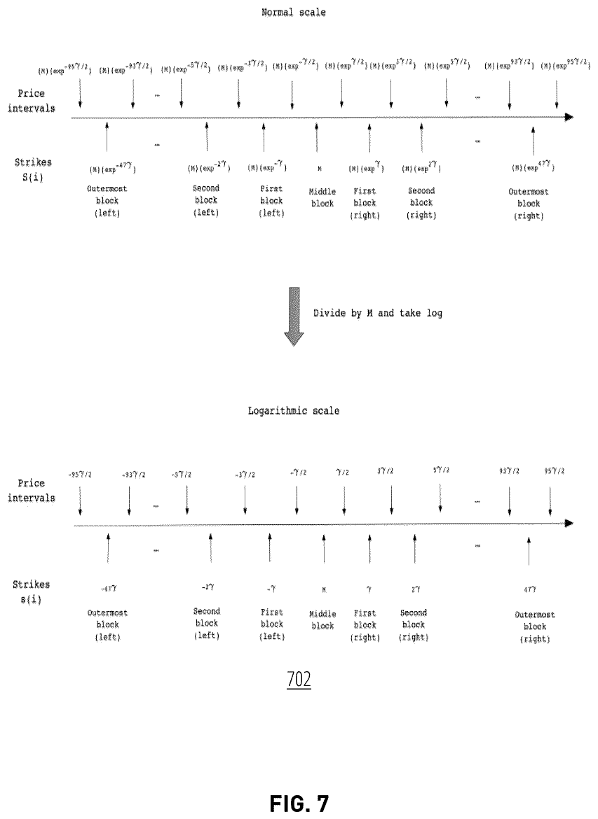

One can “rank” all defining price intervals (the “edges”) and central strikes in a normal scale, which can be converted to a logarithmic scale by dividing by M and taking the logarithm 702 as shown in FIG. 7.

Table 2 illustrates examples of different expected price ranges at maturity (95 standard risk blocks, width factor=6).

TABLE 2
Different Expected Price Ranges

| Current BTC | Implied | | | |
|---|---|---|---|---|
| trading ex- | volatility | | Expected price range for BTC | |
| change rate | over time to | width | Minimum | Maximum |
| Spot | maturity | parameter | (xmin) | (xmax) |
| (BTC/USDT) | (e.g. 1 day) | γ | (BTC/USDT) | (BTC/USDT) |
| 20,000 | 2% | 0.26% | 17,716 | 22,579 |
| 20,000 | 4% | 0.51% | 15,692 | 25,490 |
| 20,000 | 8% | 1.02% | 12,313 | 32,487 |
| 40,000 | 2% | 0.26% | 35,432 | 45,157 |
| 40,000 | 4% | 0.51% | 31,385 | 50,980 |
| 40,000 | 8% | 1.02% | 24,625 | 64,974 |

The notation S(i) is used to refer to standard risk block strikes in the normal scale, and s(i) to refer to standard risk block strikes in the logarithmic scale.

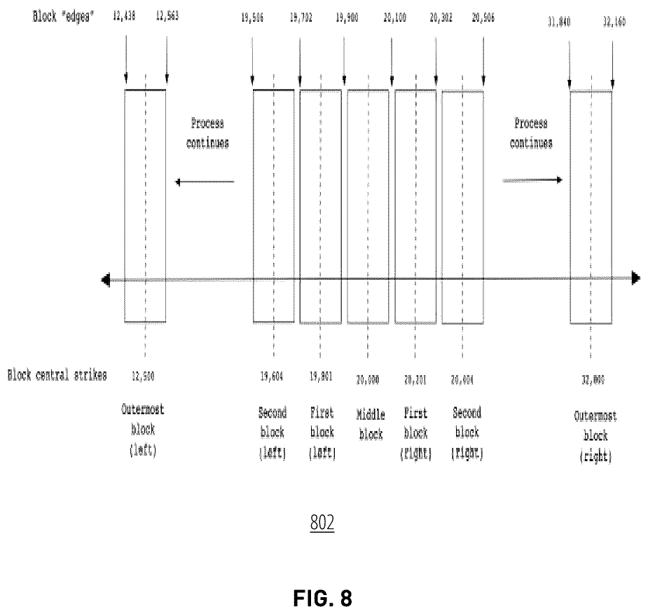

FIG. 8 is an example of standard risk block construction 802 if BTC is currently trading at BTC/USDC 20,000 and γ=1% (which corresponds to implied volatility σ≈8% over the time remaining to expiration with width factor=6).

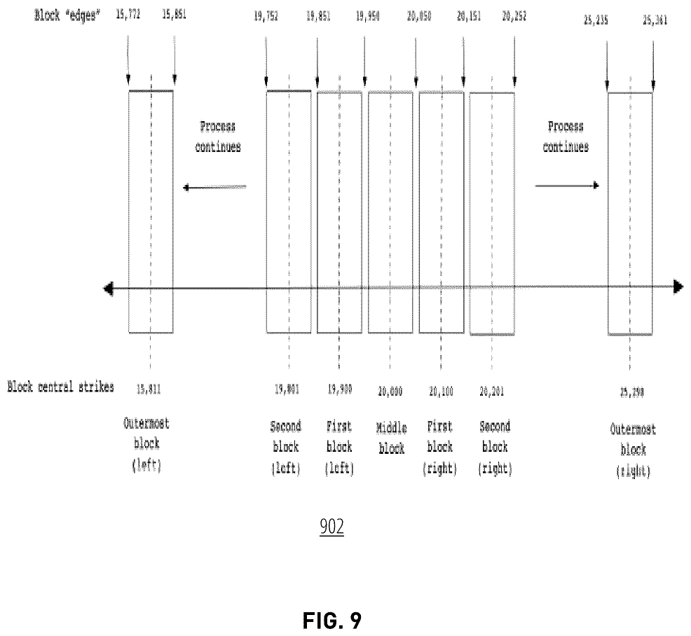

FIG. 9 provides a graphic representation 902 if BTC is currently trading at BTC/USDC 20,000 and γ=0.5% (which corresponds to implied volatility σ≈4% over the time remaining to expiration with width factor=6);

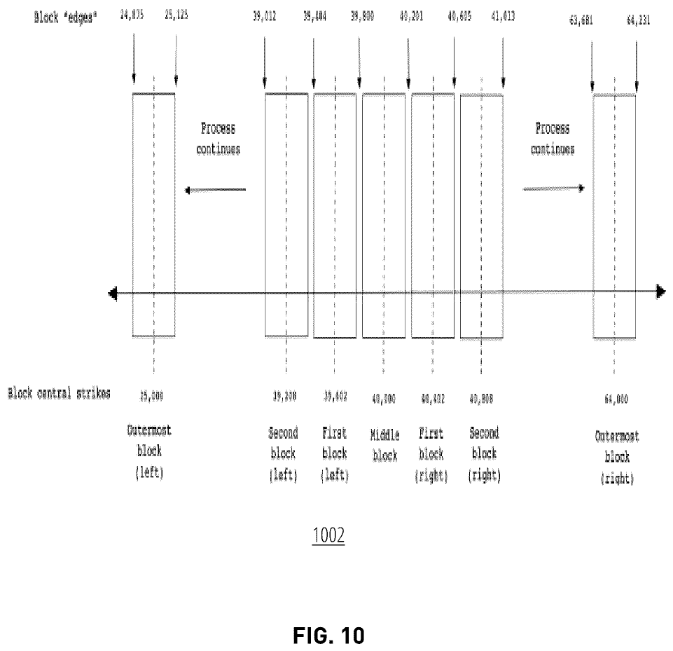

FIG. 10 illustrates a graphic representation 1002 if BTC is currently trading at BTC/USDC 40,000 and γ=1% (which corresponds to implied volatility σ≈8% over the time remaining to expiration with width factor=6);

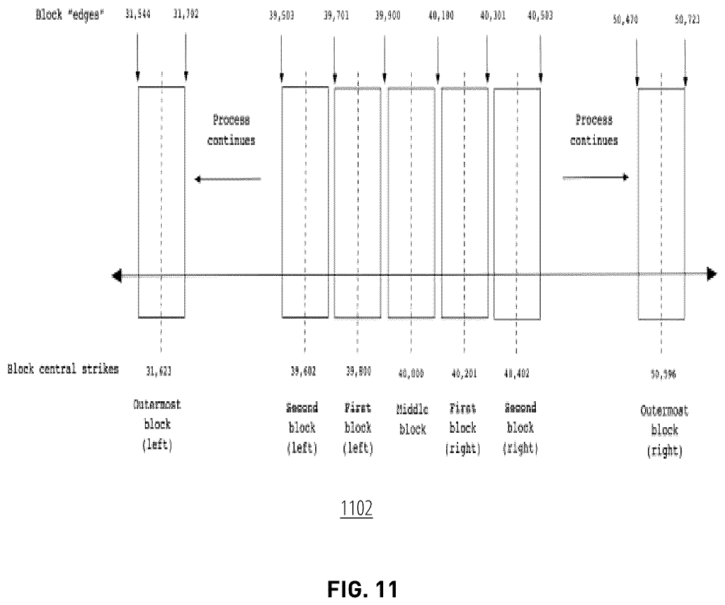

FIG. 11 illustrates a graphic representation 1102 if BTC is currently trading at BTC/USDC 40,000 and γ=0.5%, (which corresponds to implied volatility σ≈4% over the time remaining to expiration with width factor=6).

Note that standard risk blocks are of varying width. For instance, the width of the middle block is

$$M \times ( {exp}^{\frac{γ}{2}} - {exp}^{- \frac{γ}{2}} ) ,$$

the width of the first block to the left block of the middle block is

$$M \times ( {exp}^{- \frac{γ}{2}} - {exp}^{\frac{3 γ}{2}} ) ,$$

the width of the outermost left block is

$$M \times ( {exp}^{- \frac{93 γ}{2}} - {exp}^{- \frac{95 γ}{2}} ) ,$$

etc. The differences in these exponential terms are not identical. The outermost left and right standard risk blocks have the smallest and largest width respectively. Width can be gradually increasing with block central strikes. Block width is also a function of the price of the underlier at the time the option is initialized and increases with higher values of M.

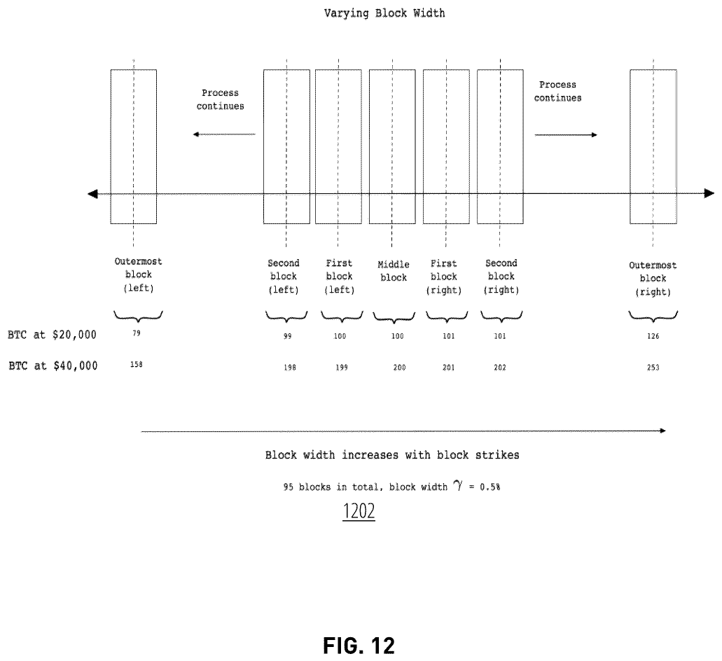

FIG. 12 provides a graphic representation 1202 and applies a width of standard risk blocks of γ=0.5% (implied volatility σ≈4% over the time remaining to expiration, with width factor=6).

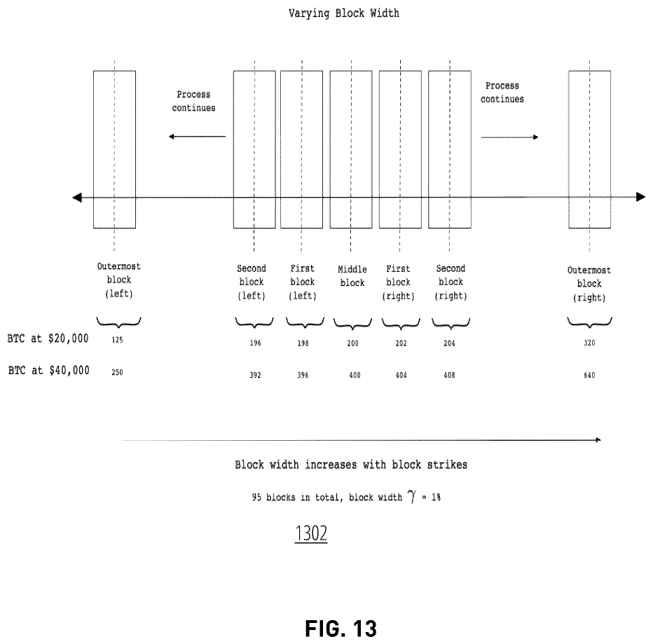

FIG. 13 provides a graphic representation 1302 and applies a width of standard risk blocks of γ=1% (implied volatility σ≈8% over the time remaining to expiration, with width factor=6).

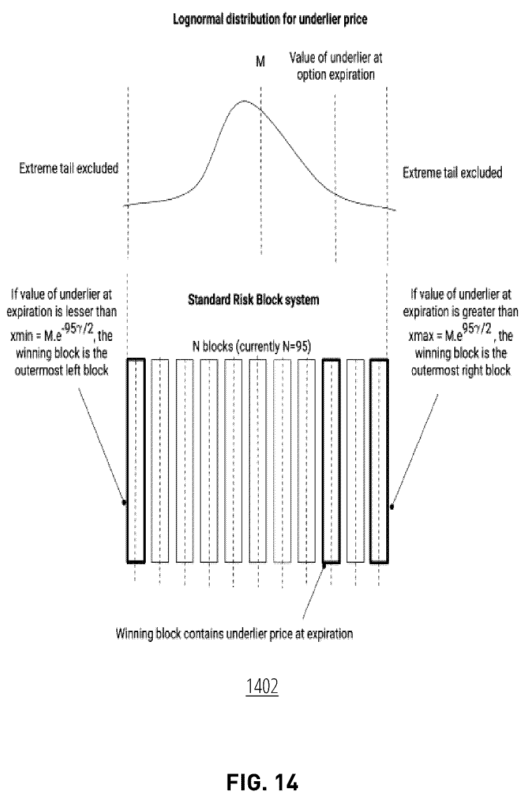

FIG. 14 illustrates a standard risk block system 1402. Each stake bought in a standard risk block pays at expiration the amount

$$lotsize = \frac{1}{{2}^{13}} = \frac{1}{8192}$$

provided the block “wins”. That is, the underlier ends up in the standard risk block's price interval. The lotsize is the smallest payment unit attached to a standard risk block, and is denominated in the base currency (e.g., USDC if the option is USDC-settled). In the (unlikely) event that the price of the underlier would end up in the extreme tails of the distribution, the outermost standard risk block would be declared the winner. If the underlier ends up above the upper bound xmax for the expected price range, the winning standard risk block is the outermost right block that contains xmax with the highest strike. If the underlier ends up below the lower bound xmin for the expected price range, the winning standard risk block is the outermost left block that contains xmin with the lowest strike.

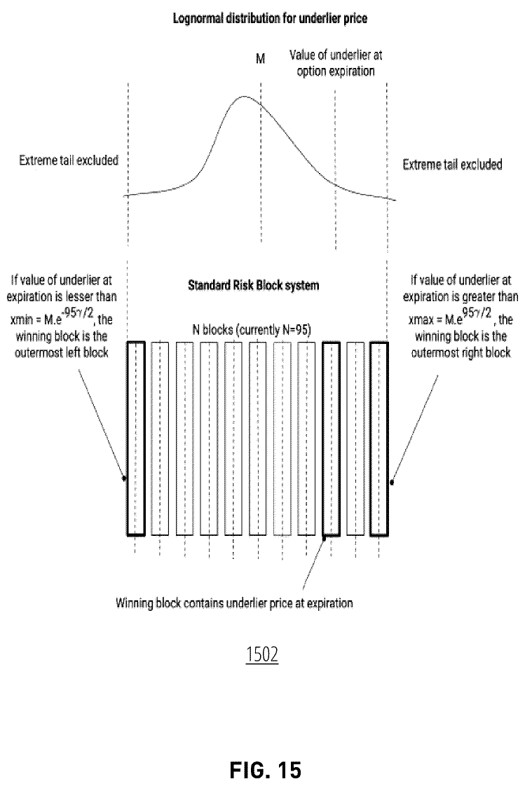

FIG. 15 illustrates an estimate of distributional tails 1502. When legacy options are converted into stakes in standard risk blocks, the number of stakes purchased in each standard risk block is determined on the basis of each block's central strike. This means that for practical purposes the value of the underlier falling below (or above) the central strike of the outermost left (or right) block is the same as if the underlier ending up in the tails. By construction, the standard risk block system is such that the difference between the central strikes of the outermost left and right blocks covers at least three standard deviations (and up to six standard deviations) on each side in the normal scale.

Given a normal distribution Y with mean μ and standard deviation σ, one finds that: (i) the interval [e^{μ-σ}, e^{μ+σ}] is the confidence interval for the lognormal variable e^{Y} with the confidence level 68%; (ii) the interval [e^{μ-2σ}, e^{μ+2σ}] is the confidence interval for the lognormal variable e^{Y} with the confidence level 95%; (iii) the interval [e^{μ-3σ}, e^{μ+3σ}] is the confidence interval for the lognormal variable e^{Y} with the confidence level 99.9%.

In one example, a provided width factor ≥3 in the normal scale. This means that the standard risk block system covers over 99% of the distribution in the lognormal scale. That is, the probability of the underlier staying in the expected range is over 99%.

Next is discussed the concept of converting legacy options into standard risk block stakes. The user interface of a user device (such as via a graphical display on the user device) connects traders to the protocol and provide them with a traditional option trading experience. Strike prices displayed on the user interface at which a traditional option can be bought or sold are equal to the central strikes of the standard risk block system. In one aspect, since there are 95 standard risk blocks, there can be 95 strike prices for traditional options on the platform. Other numbers greater than or less than 95 are contemplated as within the scope of this disclosure as well.

When a trader places an order (buy or sell) for a traditional option, the order is converted into stakes in individual standard risk blocks. The number of stakes bought in each standard risk block is designed to replicate the option payoff and is a function of the difference between the option strike price and the central strike price of the block: (1) A traditional call option with a given strike K_{call} is converted into stakes bought in all standard risk blocks with strikes above K_{call}. For all admissible standard risk blocks j>i, the total number of stakes to be bought in each j-th standard risk block is given by the formula:

$$\# stakes = \frac{{S}_{j} - {S}_{i}}{lotsize} \times Q$$

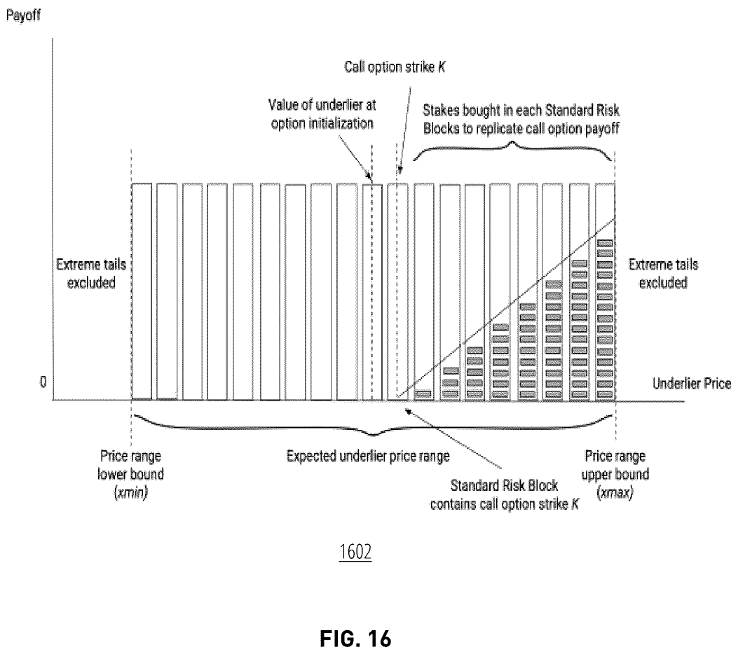

(2) A traditional put option with a given strike Kₚᵤₜ is converted into stakes bought in all standard risk blocks with strikes below Kₚᵤₜ. For all admissible standard risk blocks j<i, the total number of stakes to be bought in each j-th standard risk block is given by the formula:

$$\# stakes = \frac{{S}_{j} - {S}_{i}}{lotsize} \times Q .$$

Where the number of options being bought is Q, and Si is the central strike of the the i-th standard risk block that contains the option strike K_{call} or Kₚᵤₜ (with Sᵢ=K_{call} or Sᵢ=Kₚᵤₜ since all traditional options can be bought or sold at strikes equal to central block strikes). The linear combinations of stakes held in standard risk blocks can approximate with very good precision the payoff of any option, including standard calls and puts, but also more complex strategies. FIG. 16 illustrates the stakes 1602 being bought in each standard risk block when a trader buys a call. This figure shows replicating call option payoff with stakes in standard risk blocks.

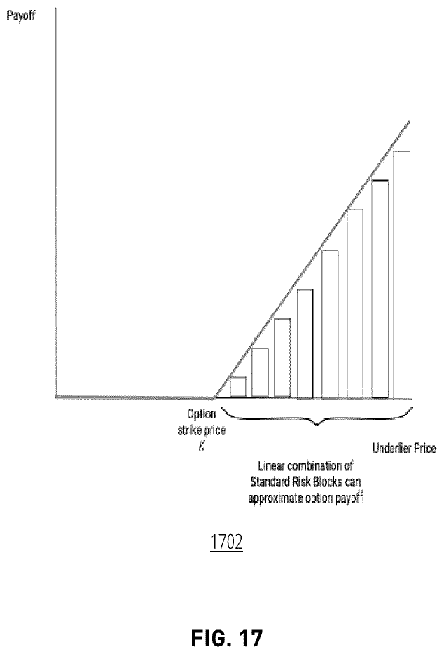

FIG. 17 illustrates graphically how the approach described above allows a trader to replicate a call option payoff. Note that traders cannot freely choose a custom strike for traditional options that they are buying or selling. The strikes displayed by the user interface are always equal to the central strikes of the standard risk block system and are not customizable. FIG. 17 illustrates call option pay via standard risk blocks 1702.

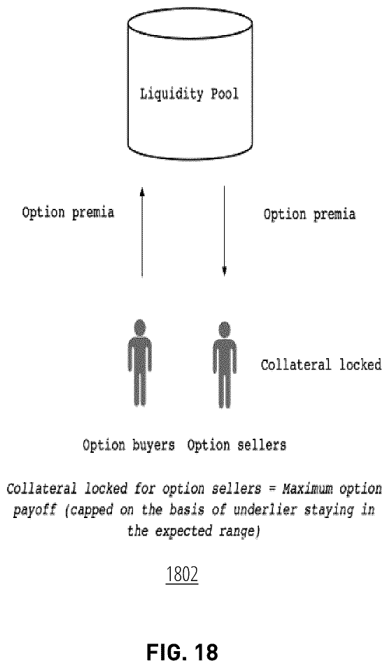

FIG. 18 illustrates trading and price discovery features 1802 when buying and selling options. The user interface ensures that traders experience buying and selling options in terms of option premia. Traders buying options pay the option premium. Traders selling options receive the option premium, and post as “collateral” the maximum potential option payout. Note that this amount is posted in the base currency (e.g., USDC), as there is no need to post the underlying digital asset (e.g., BTC), and is kept separate from the liquidity pool.

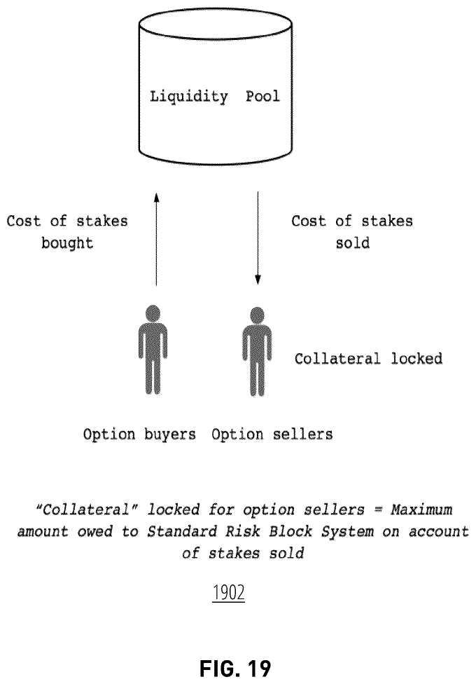

On the backend, everything is handled through the standard risk block system via the protocol as shown in FIG. 19 which illustrates buying and selling options in the standard risk block system 1902. When traders sell long positions to the pool, the collateral posted by option sellers is the maximum potential amount owed to the standard risk block system, that is the maximum amount associated with stakes sold in a single standard risk block. Option premia are computed as the price of all underlying stakes in standard risk blocks.

Note that the notional value of any trade cannot exceed 0.5% (or some other value or threshold) of the size of the liquidity pool. This threshold can be implemented to prevent the price impact from being too high and the potential for speculation.

Price discovery via AMM Pricing is described next. All options are priced on the basis of all underlying stakes purchased in standard risk block. At any given moment each central strike of a given standard risk block has an associated indicated price at which a trader can buy or sell stakes in the block. Ongoing price discovery happens through the AMM, which determines the (dynamic) price of a stake in a given standard risk block as the maximum among two preliminary prices (see Table 3 below for a list of all relevant variables): (1) The first preliminary price at time t guarantees the sufficiency of the Liquidity Pool for the pay-off in case the block wins. It is given by the formula:

$${PM}_{i} ( t ) = {( Min ( Max ( \frac{{D}_{i} ( t ) - {B}_{i} ( t )}{pool} , 0 ) , 1 ) )}^{2}$$

(2) The second preliminary price at time t is based on the contribution of the trade to the inventory risk of the liquidity pool given existing positions, and ensures the defense of liquidity providers in case of rapid price movement of the underlier, increasing the price in a standard risk block in which many stakes are bought by the traders (i.e. following the trends of the market). It is given by the formula:

$${PD}_{i} = \frac{{{D}_{i} ( t )}^{2}}{{\sum }_{i = 1}^{N} {{D}_{j} ( t )}^{2}} \\ Introducing {p}_{i} ( t ) = Max ( {PM}_{i} ( t ) , {PD}_{i} ( t ) ) , \\ which defines the final estimated price {P}_{i} ( t ) as : \\ {P}_{i} ( t ) = \frac{{{p}_{i} ( t )}^{2}}{{\sum }_{i = 1}^{N} {{p}_{j} ( t )}^{2}} \qquad ( 3 )$$

Notice that due to a normalization the sum of all Pi(t) for all blocks always equals 1 (units of the base currency) which is necessary in order to avoid arbitrage. Prices can also be interpreted as probabilities of the underlier ending up in the block.

Initial pricing is included in the process. Thinking of prices as probabilities, initial prices of standard risk blocks at the time of option initialization simply mirror the lognormal distribution estimated on the basis of the implied volatility of options from most recent expirations on the same underlier.

In one aspect, there are different types of orders that can be received from traders. The trading interface displays the estimated price of an option as a tentative potential order, based on the estimated price for the underlying collection of stakes. The final price could differ from the estimated price if there are new orders placed by other traders in the system after the estimated price was initially computed. Two types of orders can be placed, a market order and a modified limit order. A market order is an order to buy or sell an option at the final price determined by the protocol. A modified limit order allows traders to set the maximum amount they would be willing to add to the estimated cost.

TABLE 3
Relevant parameters for determination of preliminary price

| | |
|---|---|
| Dᵢ(t) = nᵢ(t) × lotsize: | Total number of stakes in the i-th standard risk |
| | block at nominal value at time t, including the |
| | stakes associated with the tentative order. |
| nᵢ(t): | The total net number of stakes that have been |
| | sold to date at time t in the i-th standard risk |
| | block since option activation, including the |
| | stakes associated with the tentative order. |
| $lotsize = \frac{1}{{2}^{13}} = \frac{1}{8192}$ | Amount denominated in the base currency (e.g. USDC if the option is USDC-settled), and |
| | paid to traders for each stake purchased in the |
| | i-th standard risk block, provided the block |
| | “wins” at expiration. |
| Bᵢ(t): | Net balance of premia at time t that the i- |
| | th standard risk block has previously obtained |
| | as a result of the buying and selling back of |
| | stakes in the i-th standard risk block, not |
| | including the stakes associated with the tentative |
| | order. |
| Pool(t): | Value of tokens locked in the liquidity pool |
| | backing the standard risk block system at time t, |
| | denominated in the base currency. |
| N: | Number of standard risk blocks (currently, N = |
| | 95 but other numbers are contemplated). |

Because an order book is not used, traditional limit orders do not exist. The modified limit order is not a limit order but an instruction from a trader on when to trade that is more akin to a “market if touched” (MIT) order. It is a way for the trader to specify the deviation from the market price that has just been quoted to them, and the actual execution price they are willing to pay. One big difference with a limit order in an order book is that there is no visibility of the modified limit order to other traders, and no impact on the price.

In one aspect, an initial inventory can impact pricing. In order to control for price sensitivity to trading activity and ensure that prices are not overtly responsive to early trading immediately after option activation, the smart contracts “purchases” (from itself) an initial “inventory” of stakes in standard risk blocks. The stakes bought by the smart contract from itself are taken into account as part of total stakes for purposes of pricing standard risk blocks during trading. However, there is no actual cash flow associated with the transaction; nor would these stakes entitle the smart contract to actual settlement.

The number of stakes n being bought in the i-th standard risk block at option initialization (t=0) is determined by the smart contract to be such that the total sum deemed invested is equal to a percentage of the liquidity pool:

$${\sum }_{i = 1}^{N} ( {n}_{i} \times {P}_{i} ) = inventory ration \times pool$$

Where P; is the initial price of the i-th standard risk block, and inventory ratio is a percentage of the liquidity pool, a parameter set by the administrator. The larger this ratio, the lower the price sensitivity to trading activity.

Liquidity pool cash flow impacts aspects of trading. During trading, there is a net cash flow associated with premia collected from option buyers and paid to option sellers. Additionally, the liquidity pool collects trading fees.

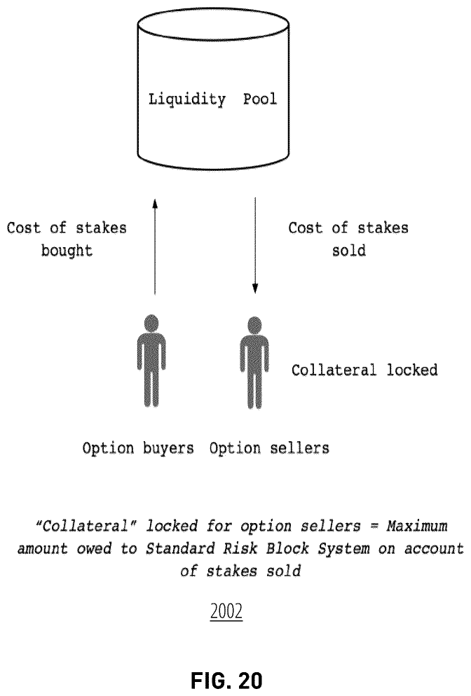

FIG. 20 illustrates a determination of winning standard risk block 2002. This relates to option expiration and final settlement. At expiration, the standard risk block that contains the underlier price is declared the winner. For purposes of determining the winning block, the value of the underlier is obtained from our own spot exchange (a constant-product AMM). The system also can use an oracle (third party source of data) as a back-up to ensure there is no significant deviation or price manipulation.

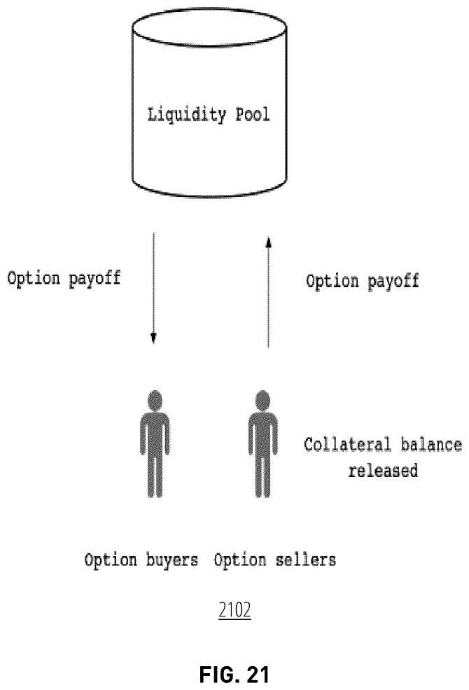

FIG. 21 illustrates a settlement process 2102 from the trader experience. At settlement, traders receive the option payoff from the liquidity pool. Funds in the liquidity pool serve as collateral. Traders who sold options pay the option payoff, and the balance of their collateral is unlocked.

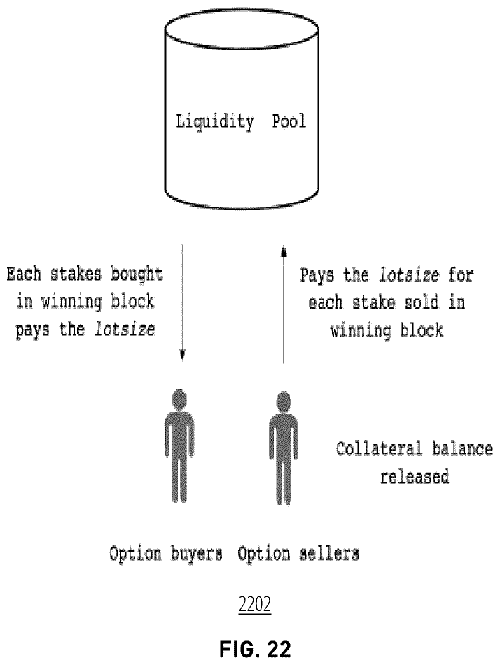

FIG. 22 illustrates settlement for the standard risk block system 2202. On the backend, settlement is handled through the standard risk block system via the protocol. Traders who bought stakes on a winning standard risk block receive the payoff (lotsize) for each stake bought in the block. Traders who sold stakes in a winning standard risk block pay the payoff (lotsize) for each stake sold in the block.

The width of standard risk blocks drives a small discrepancy between the settlement amount for an option converted into stakes in standard risk blocks, and the payoff of a traditional option. This discrepancy is driven by the fact that the payoff of a traditional option is based on the price of the underlier at expiration, whereas with standard risk blocks it is based on the central strike of the standard risk block that contains the underlier. Recall as discussed above that the number of stakes purchased in a standard risk block is a function of the difference between the central strike of the block and the option strike. There may be a small difference between the two, which at most is half of the width of the block. Sometimes this discrepancy is in favor of the trader and sometimes it is not. Assuming that the standard risk blocks are small enough, the impact will be negligible. For example, if BTC is trading at BTC/USDC 20,000 when an option is initialized, and implied volatility is 4% with 6 standard deviations, a trader can expect a discrepancy that at most ranges between USDC 40-63.

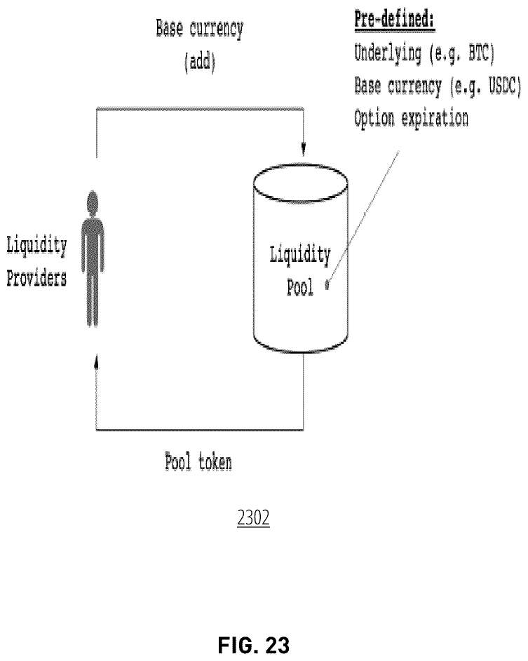

FIG. 23 illustrates how a liquidity provider contributes a base currency to the liquidity pool 2302. This can relate to deposits and withdrawals. Liquidity providers may add funds to a liquidity pool at any time. Every deposit of base currency into the liquidity pool will generate a pool token (essentially a deposit certificate).

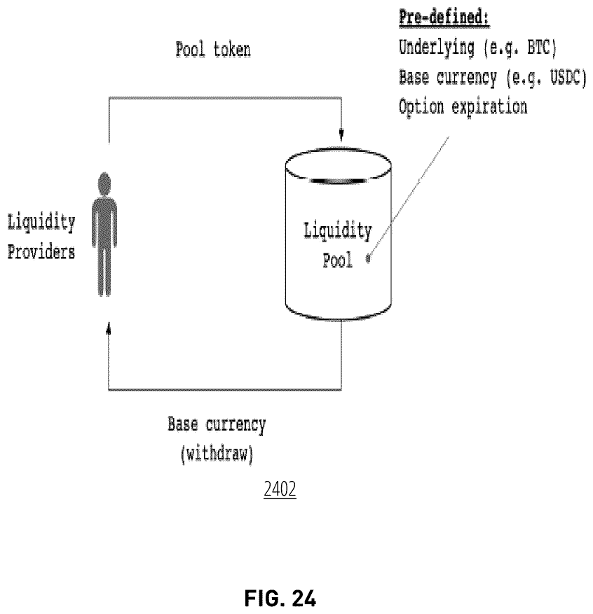

FIG. 24 illustrates how a liquidity provider withdraws base currency from the liquidity pool 2402. The pool token has to be returned to get the deposit back adjusted for profit/loss. Liquidity providers may withdraw funds from the liquidity pool at any time, selling pool tokens back to the pool. Funds withdrawn during trading are subject to early withdrawal fees as noted below.

Liquidity pool token pricing can be considered in the trading process. At any time, liquidity pool tokens are priced based on the basis of the existing total balance in the pool, reduced by the maximum payment obligation of the pool:

$$price = \frac{( pool - max obligation )}{\# tokens}$$

Where: (1) The pool balance in a given liquidity pool includes funds provided by liquidity providers, the liquidity pool share of trading fees, and the net cash flow (premia) as a result of buying and selling options; and (2) The maximum obligation of a given liquidity pool is the maximum potential payment owed by the pool (i.e. the maximum potential payment owed by the standard risk block system.)

Early withdrawal fees can apply. There is a one-hour window (or some other time frame which can be fixed or variable) after option expiration (and preceding a new option initialization) during which no penalty is applied if funds are withdrawn. However, funds withdrawn during trading (i.e., after option activation and before expiration) are subject to the following fees which are designed to incentivize good liquidity provider behavior and stay in the liquidity pool, ultimately only benefiting traders and liquidity providers as a whole: (1) Transaction fee. Applied as [e.g., 0.5%] of the amount withdrawn and designed to prevent speculation; and (2) Penalty discount. Applied as a discount (percentage) of amounts withdrawn, designed to incentivize liquidity providers to leave funds until option expiration and not deplete the pool balance below a level that would be insufficient to cover the maximum payment owed by the standard risk block system:

$$discount = {( \frac{max obligation}{adjusted pool balance} )}^{factor}$$

Where. (1) The adjusted pool balance is reduced by the amount withdrawn; and (2) The discount factor is a parameter (e.g., an integer between 1 and 6 or some other range) set by the administrator, which controls the sensitivity of the withdrawal penalty discount relative to the pressure exerted by the standard risk block system on the pool. In one aspect, the factor can equal two.

Liquidity pool profit and loss is discussed next. The liquidity pool is buying or selling options to take the opposite side of orders placed by traders, with respect to all strikes. It is not possible to predict the actual yield that a given liquidity pool will earn. The liquidity pool is earning a return from buying or selling options based on trader activity. This return depends on the pool's aggregate volatility exposure as well as the difference between realized and implied volatility and the performance of the underlying. There is no guarantee of positive returns, and the pool can experience losses. In addition, the liquidity pool receives a percentage of trading fees as compensation for providing liquidity to support option trading (see below).

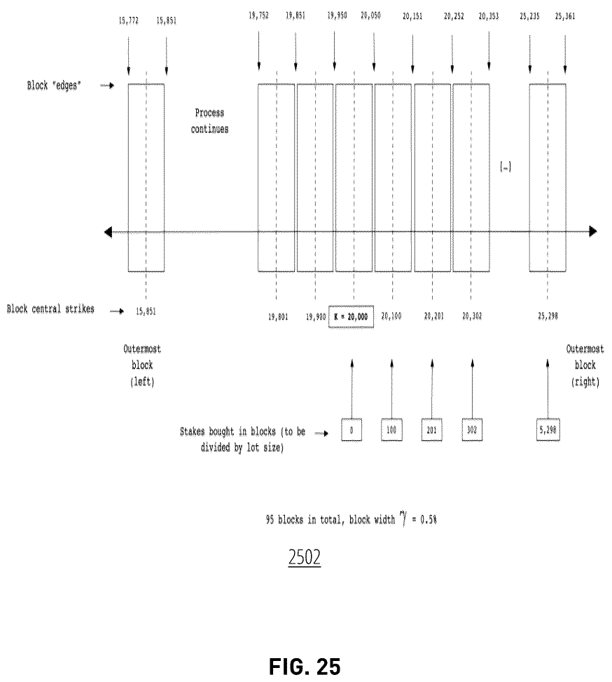

FIG. 25 illustrates an example of the standard risk block system 2502. Block construction here assumes γ=0.5%, width factor=6 and implied volatility σ=4%. In this example BTC is currently trading at BTC/USDC 20,000 and the expected range for BTC is BTC/USDC 15,772-25,361. A trader buys one ATM (at the money) call option with a strike price of BTC/USDC 20,000. FIG. 25 shows the various standard risk blocks 2502 at the time the option is initialized, and the long call option being converted into stakes bought by the trader in various standard risk blocks.

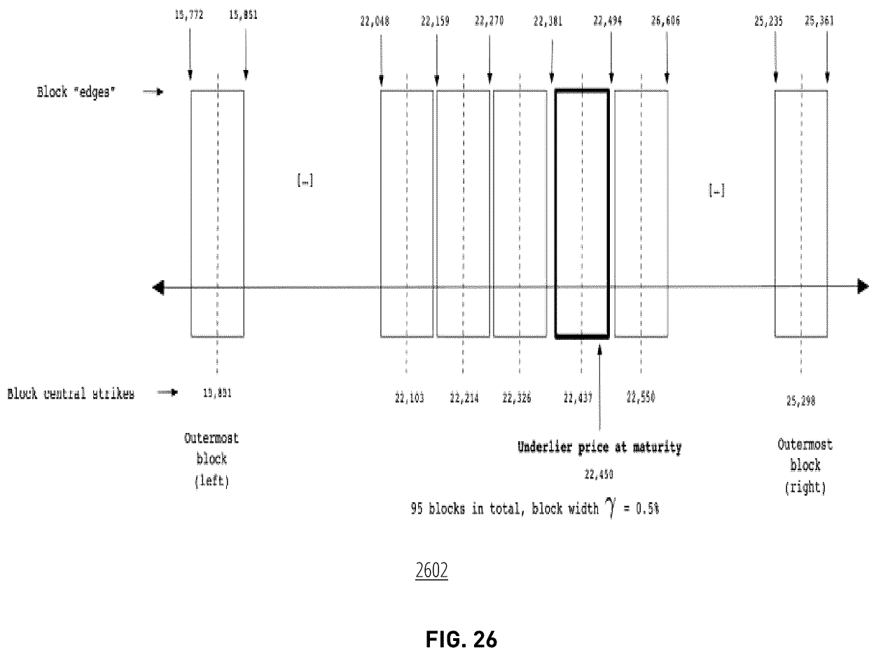

FIG. 26 illustrates an example determination of winning standard risk block 2602. At expiration BTC trades at BTC/USDC 22,450. The smart contract determines the winning standard risk block, which happens to be the standard risk block with a central strike of BTC/USDC 22,437.

$$\# stakes = \frac{22 , 437 - 20 , 000}{lotsize} = \frac{2 , 437}{lotsize}$$

The trader receives the following payout:

$$\# stakes \times lotsize = \frac{2 , 437}{lotsize} \times lotsize = USDC 2 , 437$$

Importantly, the trader only receives USDC 2,437 and not USDC 2,450 (22,450 less the option strike 20,000), which is what would have been received had the traders bought a traditional call option. This is because the standard risk block payout is a close approximation of what a trader would receive with a traditional option. There is a small discrepancy (USDC 13) to the extent that the price of the underlying cryptocurrency at expiration is not exactly the same as the central strike of the standard risk block that contains it. Note that in other situations this discrepancy can also resolve itself in the trader's favor—if at expiration the underlier would have traded between USDC 22,381 and 22,437, the winning block would have stayed the same and the standard risk block would pay more than a traditional option.

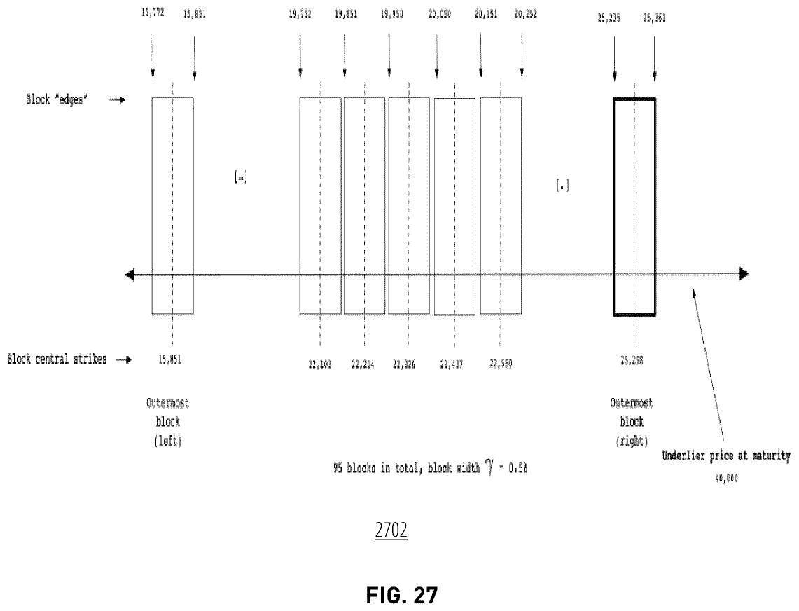

FIG. 27 illustrates an example of a determination of winning standard risk block 2702. A tail event can apply. If instead at expiration BTC trades at BTC/USDC 40,000 (well outside of the expected range), the winning standard risk block is the right out-ermost block with a central strike of BTC/USDC 25,298.

The number of stakes the trader had bought in that block:

$$\# stakes = \frac{25 , 298 - 20 , 000}{lotsize} = \frac{5 , 298}{lotsize}$$

The trader receives the following payout:

$$\# stakes \times lotsize = \frac{5 , 298}{lotsize} \times lotsize = USDC 5 , 298$$

Critically, the trader does not receive USDC 20,000, as would have been the case with a regular option based on BTC trading at BTC/USDC 40,000, due to the fact that the payout is capped to the right outermost standard risk block with a central strike of BTC/USDC 25,298. When the underlier ends up in the tails of the distribution, payment to the trader may end up significantly differing from the payoff of a legacy option with the same strike, underlier and maturity. This is a feature of the protocol, not a bug, and the price to pay for a fully collateralized option with no counterparty risk. In our view, even though on the system all options are really spreads, this is of little practical relevance because the expected price range covers over 99% (at least 99.9%) of the distribution.

The approach disclosed provides capital efficiency. In one aspect this applies for liquidity providers. Option combinations are automatically cross-collateralized, which adds capital efficiency. Despite full collateralization, the system can back up substantially more option contracts than a traditional market maker in terms of pre-trade liquidity associated with initial margin requirements. This is because on a traditional exchange, market makers need to put up an initial margin for each listed contract (each strike each viewed as a separate instrument), whereas with the system, a given liquidity pool can potentially support a large variety of option strikes derived from all possible linear combinations of standard risk blocks. For a market involving a large number of strikes, as well as more complicated multi-legged instruments necessitating multiple calls and strikes, this advantage becomes substantial.

On a traditional exchange, initial margin requirements for option sellers differ depending on various underlying securities and the type of option (vanilla vs. multi-leg), but are typically equal to a percentage of the value of the underlying (less the out-of-the-money amount if applicable), to a minimum of (i) for calls 10% of the underlying security/index value; (ii) for puts, 10% of the put exercise price. If a market maker is offering to write both calls and puts for the same underlying security, the margin initial requirement is the short put or short call requirement, whichever is greater.

Consider a traditional market maker offering to sell calls and puts across N=95 strikes (or some other number of strikes). A conservative estimate of the capital (margin requirement) needed by a traditional market maker to make these options available for sale is 95×10%×M, where M is the market value of the underlying. On the system, a liquidity pool of size xmax−xmin supports the potential sale of any single call or put of any strike contained within the range. This is because the maximum payoff associated with any in-the-money call or put would never exceed xmax−xmin. This assumes full collateralization. The system is more capital efficient than a classical market maker case when:

(xmax−xmin)<95×10%×M

Importantly, capital efficiency here refers to less capital being required to support the potential (not actual) sale of calls or puts within the price range. The ratio can also be formally defined as the capitol required on the system relative to minimum capital required in the traditional case, as being:

$$\frac{( x max - x min )}{95 \times 10 \% \times M}$$

For example, if BTC is currently trading at BTC/USDT 20,000, with xmin=12, 438 and xmax=32, 160, this capital ratio would be equal to:

$$\frac{( 32 , 160 - 12 , 438 )}{( 95 \times 10 \% \times 20 , 000 )} = 10.38 \%$$

Meaning that pre-sale, the capital needed to list all strikes on the system would only be 10.38% of the capital required by a traditional market maker.

In one aspect, a platform using the disclosed pricing AMM but applying some kind of margin percentage (e.g., only 10% of capital in the liquidity pool) as opposed to full collateralization would become even more efficient. The capital ratio would become:

$$10 \% \times \frac{( x max - x min )}{95 * 10 \% * M} = \frac{( x max - x min )}{95 \times M}$$

In our above example with BTC currently trading at BTC/USDT 20,000 and xmin=12,438 and xmax=32,160, the platform would become 99% more efficient than a traditional market maker with a capital ratio of only

$$\frac{( 32 , 160 - 12 , 438 )}{95 \times 20 , 000} .$$

The inventors are not suggesting the desirability of anything less than full collateralization, only highlighting the benefits of the AMM approach.

Capital efficiency can also apply for traders. In terms of collateral posted by traders selling options (i.e., specific strikes), there is also capital efficiency associated with natural netting. For example, if someone is selling one call option and one put option simultaneously, they only have to post collateral for maximum risk rather than posting double collateral (i.e., for each option separately) as might be the case with some option vaults.

Traders are charged a flat transaction fee of 10 basis points (0.10% or some other value) on the notional value of each trade, regardless of the number of legs in a trade. This trading fee is split between liquidity providers and the system. Liquidity providers receive 50% (or some other percentage) of trading fees generated from trades that they provide collateral for. Note that during the promotional period, this share will be increased to 75% (or some other value) to incentivize liquidity provision.

Tokenomics are discussed next. Every deposit of base currency into a liquidity pool will generate a pool token (essentially a deposit certificate) which has to be returned to get the deposit back adjusted for profit/loss. The tokens would reside in the user's wallet and behave the same as any other ERC-20 token. Other tokens can be used in the ecosystem, including a utility token that would give users a discount on trading fees, as well as potentially a governance token.

The process for trading options is automated and implemented via a smart contract operating on a blockchain network. A branch is a chain of options scheduled to be initialized with periodic frequency. Each branch has a start date, which is time that the first option is activated in the branch. All options in the branch have the same trading pair and option “duration” which can be related to a time to maturity or an expiration time. A trading pair is the combination of a specific underlying asset, and the currency for settlement (e.g., initially, a stablecoin or some other currency) as there is no delivery of the underlying (options are “cash-settled” or rather “crypto-settled). Each expiration is backed by a specific liquidity pool.

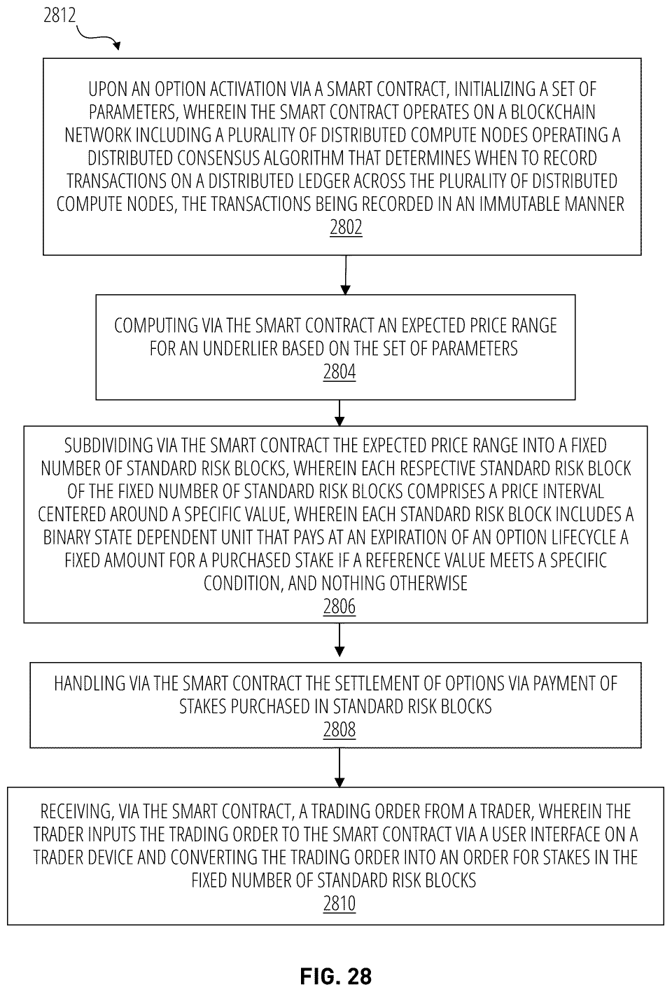

An option lifecycle can be described as follows with reference to FIG. 28. For one specific expiration in a branch, the process automated in the smart contract can be as follows. In a first phase of a method 2812 for trading option can include upon an option activation via a smart contract, initializing a set of parameters, wherein the smart contract operates on a blockchain network including a plurality of distributed compute nodes operating a distributed consensus algorithm that determines when to record transactions on a distributed ledger across the plurality of distributed compute nodes, the transactions being recorded in an immutable manner (2802).

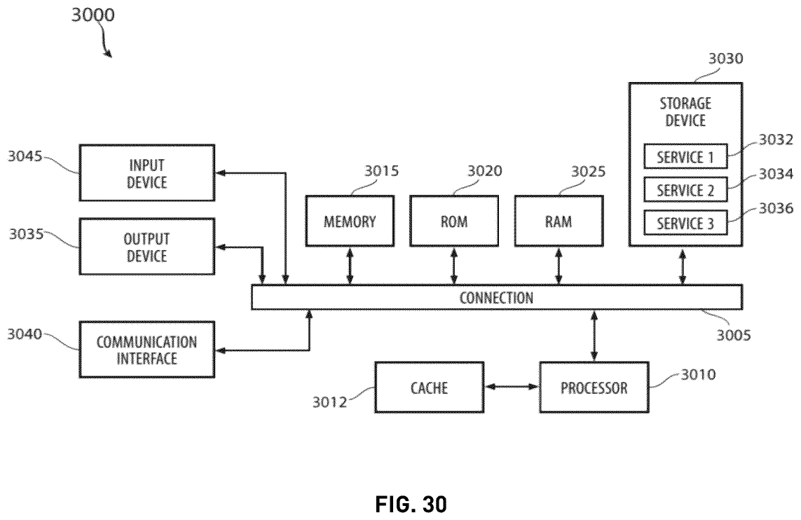

The blockchain can include a number of distributed nodes or computing devices, each having at least some of the hardware components of FIG. 30. Each of the distributed nodes includes an instance of a distributed consensus algorithm in which according to the structure or requirements of the algorithm, a certain percentage or threshold of the participants needs to agree that a transaction is valid. If a transaction is valid and thus approved for recording, then the transaction is recorded as a new block in a blockchain on the distributed ledger in which each node has a respective instance of copy of the ledger. In this manner, the blockchain network differs from a single generic computer or computer processor which has no distributed nature, no distributed consensus algorithm and no distributed ledger. Table 1 above can illustrate the various parameters that can be initialized.

Another step in the method 2812 relates to standard risk block construction. The method can include computing via the smart contract an expected price range for an underlier based on the set of parameters (2804). The method can include subdividing via the smart contract the expected price range into a fixed number of standard risk blocks, wherein each respective standard risk block of the fixed number of standard risk blocks includes a price interval centered around a specific value, wherein each standard risk block includes a binary state dependent unit that pays at an expiration of an option lifecycle a fixed amount for a purchased stake if a reference value meets a specific condition, and nothing otherwise (2806). The method can further include handling via the smart contract the settlement of options via payment of stakes purchased in standard risk blocks (2808).

The method can include receiving, via the smart contract, a trading order from a trader, wherein the trader inputs the trading order to the smart contract via a user interface on a trader device and converting the trading order into an order for stakes in the fixed number of standard risk blocks (2810).

The method can further include, during trading, each standard risk block being dynamically priced to reflect supply and demand and a sufficiency of a liquidity pool for option payoff.

The smart contract computes an expected range for the underlier on the basis of initial parameters (e.g., a spot value of the underlier, number of standard deviations to be covered). In other words, the system clips off the tails of the distribution so that unrealistic price movements of the underlier are excluded but still cover over 99% of the distribution. The smart contract further subdivides this expected price range into a fixed number of standard risk blocks. The number can be 95 blocks on Solana. Other numbers can be applied as well and the number may be fixed or dynamic. A standard risk block is a price interval centered around a specific value (e.g., central strike price). They are binary “state dependent” units that pay at expiration a fixed amount (called the lot size) for each stake purchased, but only the value of underlier is contained in the block's interval, and nothing otherwise.

Table 2 above shows some examples of different expected price ranges (e.g., given different spot values, implied volatility and width parameters). Also, the system assumes a specific distribution for the underlier (lognormal), but it would work equally with different assumptions on the distribution.

FIG. 6 above shows the details of the construction including formulas for determining the central strikes below and formulas for price intervals above. Other figures show various examples for illustration purposes. Ultimately, there could be different ways of constructing these blocks. The main idea is that the system subdivides the expected range into units, which are in essence small price intervals. Various example formulas are disclosed above as one implementation of the concept, but ultimately the system could subdivide differently.

In a second phase, the system performs option trading and market discovery. In this phase, traders connect to the smart contract via the user interface, which converts a traditional order (buy/sell an option) into an order for stakes in standard risk blocks (buy/sell stakes). There is an overall approach to pricing. Market participants interact with a user interface on a user device that has the feel of a regular option trading platform. It lists all strikes at which participants can buy or sell options. All strikes that are displayed are the central strikes of the standard risk blocks. Each standard risk block is priced separately (i.e., has its own price). One can think of prices as probabilities (because of normalization→add up to 1). That is, the price of each block will reflect the likelihood that the block will contain the value of the underlier at expiration.

Initial prices of standard risk blocks at the time of option initialization mirror the initial distribution at the time the option is activated. At the very beginning, when the platform is launched, this will be manually set. After launch, the distribution can be estimated on the basis of the implied volatility of options from most recent expirations on the same underlier.

Price discovery is another aspect of the system. During trading, standard risk blocks are dynamically priced to reflect supply and demand and the sufficiency of the liquidity pool for option payoff. All the formulas are provided above for the pricing process.

When a trader places an order, the price they pay isn't equal to the price/probability of the block just before they place the order, but takes into account the impact of the order itself on: (1) the liquidity conditions. For example, if it's putting pressure of the liquidity available, this is the first formula above which is designed to price each block based on the sufficiency of the liquidity pool for the pay-off in case the block wins; and (2) the inventory conditions. This relates to the second formula above which is designed to ensure the defense of liquidity providers in case of rapid price movement of the underlier. If there is a sudden spike in demand for a particular block it will become more expensive. The second preliminary price ensures the defense of liquidity providers in case of rapid price movement of the underlier, increasing the price in a standard risk block in which many stakes are bought by the traders.

This approach (which can be called an impact function) is supposed to replicate the logic of a market maker in traditional markets. Ultimately though, one could conceive different possible formulas and ways to do achieve this result.

In one aspect, the specific value can include a central strike price and wherein the reference value is a value of an underlier. The specific condition is that the reference value be contained in the price interval of the respective standard risk block.

The set of parameters can include one or more of the underlier, an activation date and an expiration date of an option, a spot value of the underlier, the expected price range for the underlier at expiration, and a number of standard deviations to be covered. The expected price range for the underlier can be computed based on a spot value of the underlier, an implied volatility of the underlier, and a number of standard deviations to be covered.

A respective central strike price of the respective standard risk block can be computed based on a spot value and an implied volatility of the underlier, a number of standard deviations to be covered, and a number of standard risk blocks in the fixed number of standard risk blocks.

Price intervals of the fixed number of standard risk blocks can be computed based on a spot value and an implied volatility of the underlier, a number of standard deviations to be covered, and a number of standard risk blocks within the fixed number of standard risk blocks.

The method can further include receiving, via the smart contract, a trading order from a trader, wherein the trader inputs the trading order to the smart contract via a user interface on a trader device and converting the trading order into an order for stakes in the fixed number of standard risk blocks.

The user interface presents a list of all strikes at which participants can buy or sell options. Each standard risk block of the fixed number of standard risk blocks is priced separately.

A respective initial price of each respective standard risk block at a time of option initialization is set based on a probability distribution of the underlier, which itself is based on an implied volatility of options from a most recent expiration of a same underlier.

In another aspect, the method can include during trading, each standard risk block is dynamically priced to reflect supply and demand and a sufficiency of a liquidity pool for option payoff. A price paid by the trader is not equal to a price of an associated standard risk block just before the trader places the trading order.

The price paid by the trader takes into account an impact of the trading order on both liquidity conditions including a size of a trade relative to an available liquidity in the liquidity pool and inventory conditions including a size and a contribution of the trade to an overall risk associated payment obligations of the liquidity pool.

The process regarding when a trader places an order is summarized as follows. In a first step, an order (for a legacy option) is converted into standard risk blocks. Traders buy and sell options via standard risk blocks. The formulas for how many stakes are bought (or sold) are provided above. These formulas are designed to replicate the payoff of a traditional option. If the block wins (at an expiration time), given the number of stakes purchased, the payment the trader will get ends up being very close to the payment that would be received with a traditional option.

In a second step, the order is given a tentative price on the basis of all stakes in standard risk blocks being bought. A trading interface on a user device or a trader device can display the estimated price of an option as a tentative potential order. Two types of orders can be placed, a market order and a modified limit order. A market order is an order to buy or sell an option at the final price determined by the protocol. A modified limit order allows traders to set the maximum amount they would be willing to add to the estimated cost.

Because an order book is not used, this is not a traditional limit order. It is a way for the trader to specify the deviation from the market price that has just been quoted to them, and the actual execution price they're willing to pay. One big difference with a limit order in an order book is that there is no visibility of the modified limit order to other traders, and no impact on the price.

In a third step, the order is executed. Another phase relates to the option expiration and settlement process handled by the smart contract. For example, an option may expire at 8:00 am UTC.

A first step of this phase involves identifying a winning standard risk block. The winning block contains the value of the underlier at expiration. This value could come from an oracle. In our case, it comes from our own constant-product AMM for the spot exchange. A second step involve settlement. Each stake purchased in a standard risk block pays the lotsize amount, denominated in base currency (i.e., a stablecoin). The result is that traders receive the option payoff. Funds in the liquidity pool serve as collateral for the payoff. If the value of the underlier ends up in the tails of the distribution (i.e., outside of the expected range), the winning block is the outermost block to the left or to the right, depending on which tail the result ends up in. The result is that the payment to the trader is the same as if the underlier had ended up at the maximum or minimum of the range. A trader will not benefit from price increases or decreases outside the expected range.

Additionally, note that the amount that a trader receives will not be exactly the same as with a traditional option. There will be a small discrepancy. In a traditional option, the payment of an in-the-money option is based on the difference between the option strike and the value of the underlying at expiration. With the disclosed system, the payment received depends on the number of stakes purchased in the winning standard risk block—which is based on the difference between the original option strike and the central strike of each block.

The payment can be the same as long as the underlying ends up in the winning block—that is, different values of the underlying result in the same option payment as long as they are all in the same winning block. If the value of the underlying at expiration coincides with the block's central stake, the payment is the same as with a traditional option. However, if the value of the underlying at expiration is slightly lower or higher than the block central strike value, the payment received with the system will be slightly higher or lower (respectively) than the payment received with a traditional option. The smaller the width of the risk block, the smaller the potential discrepancy.

A system for trading options can include: at least one processor; and a computer-readable storage medium storing instructions which, when executed by the at least one processor, causes the at least one processor to perform operations including one or more of: upon an option activation via a smart contract, initializing a set of parameters, wherein the smart contract operates on a blockchain network including a plurality of distributed compute nodes operating a distributed consensus algorithm that determines when to record transactions on a distributed ledger across the plurality of distributed compute nodes, the transactions being recorded in an immutable manner; computing via the smart contract an expected price range for an underlier based on the set of parameters; subdividing via the smart contract the expected price range into a fixed number of standard risk blocks, wherein each respective standard risk block of the fixed number of standard risk blocks includes a price interval centered around a specific value, wherein each standard risk block includes a binary state dependent unit that pays at an expiration of an option lifecycle a fixed amount for a purchased stake if a reference value meets a specific condition, and nothing otherwise; and handling via the smart contract a settlement of options via payment of stakes purchased in standard risk blocks.

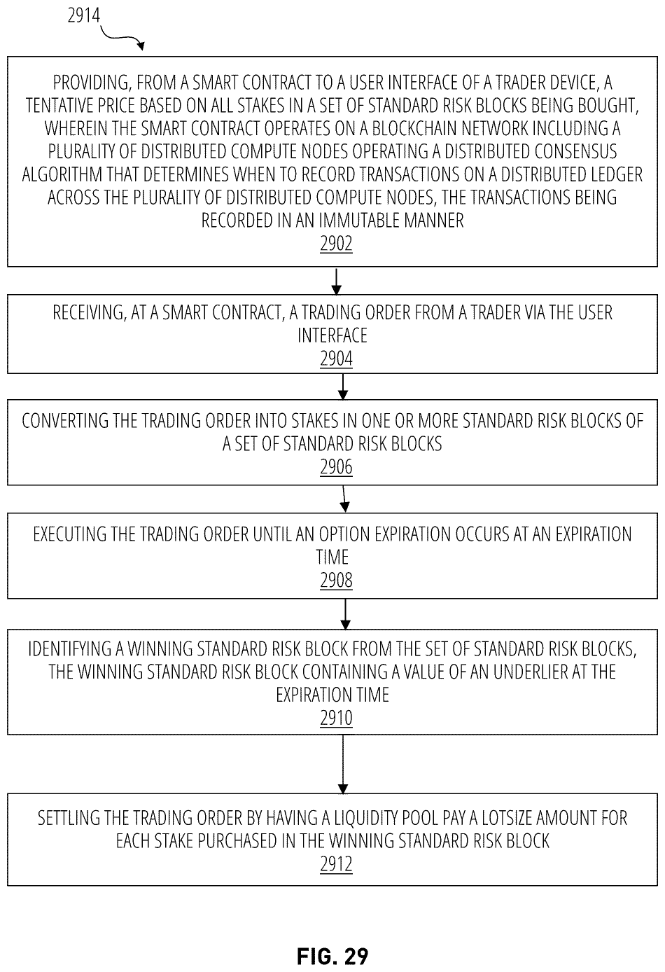

FIG. 29 illustrates a method 2914 of trading options. The method can include providing, from a smart contract to a user interface of a trader device, a tentative price based on all stakes in a set of standard risk blocks being bought, wherein the smart contract operates on a blockchain network including a plurality of distributed compute nodes operating a distributed consensus algorithm that determines when to record transactions on a distributed ledger across the plurality of distributed compute nodes, the transactions being recorded in an immutable manner (2902); receiving, at a smart contract, a trading order from a trader via the user interface (2904); converting the trading order into stakes in one or more standard risk blocks of a set of standard risk blocks (2906); executing the trading order until an option expiration occurs at an expiration time (2908); identifying a winning standard risk block from the set of standard risk blocks, the winning standard risk block containing a value of an underlier at the expiration time (2910); and settling the trading order by having a liquidity pool pay a lotsize amount for each stake purchased in the winning standard risk block (2912). The trading order can be one of a market order and a modified limit order. Funds in a liquidity pool can serve as collateral for paying the lotsize amount. In one aspect, if the winning standard risk block is within a tail of a distribution of the set of standard risk blocks, then the smart contract treats the winning standard risk block as though it was at a maximum or minimum of an expected price range associated with the distribution. The total payment amount on account of a trading order depends on a number of stakes purchased by the trader in the winning standard risk block, which is based on a difference between an original option strike and a central strike value of the winning standard risk block.

Each standard risk block of the set of standard risk blocks can include a width which determines a size of a potential discrepancy between the total amount (number of stakes times the lotsize) paid for the trading order relative to a traditional option payout.

The total amount paid for the trading order (on account of all the stakes) can be higher than the traditional option payout when a value of an underlier at the expiration time is higher than a block central strike value for the winning standard risk block and wherein the total amount paid for the trading order is lower than the traditional option payout when the value of the underlier at the expiration time is lower than the block central strike value for the winning standard risk block.

The disclosed technology involves systems, methods, and computer-readable media for providing a new options cryptocurrency trading platform. First, this disclosure presents in FIG. 30 the computer hardware components that can be used in computers as part of this disclosure. The system of FIG. 30 can be used as part of a cryptocurrency or blockchain network.

A system for trading options can include: at least one processor; and a computer-readable storage medium storing instructions which, when executed by the at least one processor, causes the at least one processor to perform operations including one or more of: providing, from a smart contract to a user interface of a trader device, a tentative price based on all stakes in a set of standard risk blocks being bought, wherein the smart contract operates on a blockchain network including a plurality of distributed compute nodes operating a distributed consensus algorithm that determines when to record transactions on a distributed ledger across the plurality of distributed compute nodes, the transactions being recorded in an immutable manner; receiving, at a smart contract, a trading order from a trader via the user interface; converting the trading order into stakes in one or more standard risk blocks of a set of standard risk blocks; executing the trading order until an option expiration occurs at an expiration time; identifying a winning standard risk block from the set of standard risk blocks, the winning standard risk block containing a value of an underlier at the expiration time; and settling the trading order by having a liquidity pool pay a lotsize amount for each stake purchased in the winning standard risk block.

FIG. 30 illustrates an example computing system architecture of a system 3000 which can be used to process data operations and requests, store data content and/or metadata, and perform other computing operations. In this example, the components of the system 3000 are in electrical communication with each other using a connection 3005, such as a bus. The system 3000 includes a processing unit (CPU or processor) 3010 and a connection 3005 that couples various system components including a memory 3015, such as read only memory (ROM) 3020 and random access memory (RAM) 3025, to the processor 3010. The system 3000 can include a cache of high-speed memory connected directly with, in close proximity to, or integrated as part of the processor 3010. The system 3000 can copy data from the memory 3015 and/or the storage device 3030 to cache 3012 for quick access by the processor 3010. In this way, the cache can provide a performance boost that avoids processor 3010 delays while waiting for data. These and other modules can control or be configured to control the processor 3010 to perform various actions. Other memory 3015 may be available for use as well. The memory 3015 can include multiple different types of memory with different performance characteristics. The processor 3010 can include any general purpose processor and a hardware or software service, such as service 1 3032, service 2 3034, and service 3 3036 stored in storage device 3030, configured to control the processor 3010 as well as a special-purpose processor where software instructions are incorporated into the actual processor design. The processor 3010 may be a completely self-contained computing system, containing multiple cores or processors, a bus, memory controller, cache, etc. A multi-core processor may be symmetric or asymmetric.

To enable user interaction with the computing system 3000, an input device 3045 can represent any number of input mechanisms, such as a microphone for speech, a touch-sensitive screen for gesture or graphical input, keyboard, mouse, motion input, speech and so forth. An output device 3035 can also be one or more of a number of output mechanisms known to those of skill in the art. In some instances, multimodal systems can enable a user to provide multiple types of input to communicate with the computing system 3000. The communications interface 3040 can generally govern and manage the user input and system output. There is no restriction on operating on any particular hardware arrangement and therefore the basic features here may easily be substituted for improved hardware or firmware arrangements as they are developed.

Storage device 3030 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 3025, read only memory (ROM) 3020, and hybrids thereof. The storage device 3030 can include services 3032, 3034, 3036 for controlling the processor 3010. Other hardware or software modules are contemplated. The storage device 3030 can be connected to the connection 3005. In one aspect, a hardware module that performs a particular function can include the software component stored in a computer-readable medium in connection with the necessary hardware components, such as the processor 3010, connection 3005, output device 3035, and so forth, to carry out the function.

For clarity of explanation, in some instances the present technology may be presented as including individual functional blocks including functional blocks including devices, device components, steps or routines in a method embodied in software, or combinations of hardware and software. In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general-purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

As noted above, the system disclosed herein may be used in a blockchain network. A blockchain network in one example is a technical infrastructure that provides ledger and smart contract (chaincode) services to applications. Primarily, smart contracts are used to generate transactions which are subsequently distributed to every peer node in the network where they are immutably recorded on their copy of the ledger. In one aspect, a consensus algorithm is distributed across the nodes where the various nodes need to agree on a transaction that is recorded across the distributed ledger. For example, each node of the distributed nodes may operate an instance of the consensus algorithm. The users of applications might be end users using client applications or blockchain network administrators.

In most cases, multiple organizations come together as a consortium to form the network and their permissions are determined by a set of policies that are agreed by the consortium when the network is originally configured. Importantly, a blockchain network differs from a generic computer in that it includes distributed compute nodes and runs a consensus algorithm across the distributed compute nodes such that the data recorded across the distributed ledger is immutable and cannot be changed. In one respect this involves a transformation of the data into a different state or thing. For example, prior to recording, the data associated with a transaction (a cryptocurrency is transferred from a seller to a buyer, which transaction needs to be recorded), is simply data stored in a computer member associated with an exchange. It would be in a state of possibly being altered or deleted via for example a hacker. However, the data once it is recorded on the distributed ledger has changed states. It has become an immutable recording of the data and is thus in a different state than before. This can only be accomplished through using particular machine which is the blockchain network as run by a smart contract to perform the operations disclosed herein. Thus, it is not possible via a simple generic computer which would merely record data of a transaction on in a memory which could be hacked and as a basic matter is not immutable.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

While the trading network could apply to cryptocurrencies, or securities, it would also be used to trade any other item (digital or physical) of value.

The following are clauses describing the various concepts disclosed herein:

Clause 1. A method for trading options, the method comprising: upon an option activation via a smart contract, initializing a set of parameters, wherein the smart contract operates on a blockchain network comprising a plurality of distributed compute nodes operating a distributed consensus algorithm that determines when to record transactions on a distributed ledger across the plurality of distributed compute nodes, the transactions being recorded in an immutable manner; computing via the smart contract an expected price range for an underlier based on the set of parameters; subdividing via the smart contract the expected price range into a fixed number of standard risk blocks, wherein each respective standard risk block of the fixed number of standard risk blocks comprises a price interval centered around a specific value, wherein each standard risk block comprises a binary state dependent unit that pays at an expiration of an option lifecycle a fixed amount for a purchased stake if a reference value meets a specific condition, and nothing otherwise; and handling via the smart contract a settlement of options via payment of stakes purchased in standard risk blocks.

Clause 2. The method of clause 1, wherein the specific value comprises a central strike price and wherein the reference value is a value of an underlier.

Clause 3. The method of any previous clause, wherein the specific condition is that the reference value be contained in the price interval of the respective standard risk block.

Clause 4. The method of any previous clause, wherein the fixed number of standard risk blocks comprises 95.

Clause 5. The method of any previous clause, wherein the set of parameters comprise the underlier, an activation date and an expiration date of an option, a spot value of the underlier, the expected price range for the underlier at expiration, and a number of standard deviations to be covered.

Clause 6. The method of any previous clause, wherein the price interval comprises a small price interval.

Clause 7. The method of any previous clause, wherein the expected price range for the underlier is computed based on a spot value of the underlier, an implied volatility of the underlier, and a number of standard deviations to be covered.

Clause 8. The method of any previous clause, wherein a respective central strike price of the respective standard risk block is computed based on a spot value and an implied volatility of the underlier, a number of standard deviations to be covered, and a number of standard risk blocks in the fixed number of standard risk blocks.

Clause 9. The method of any previous clause, wherein price intervals of the fixed number of standard risk blocks are computed based on a spot value and an implied volatility of the underlier, a number of standard deviations to be covered, and a number of standard risk blocks within the fixed number of standard risk blocks.

Clause 10. The method of any previous clause, further comprising: receiving, via the smart contract, a trading order from a trader, wherein the trader inputs the trading order to the smart contract via a user interface on a trader device; and converting the trading order into an order for stakes in the fixed number of standard risk blocks.

Clause 11. The method of clause 10 or any previous clause, wherein the user interface presents a list of all strikes at which participants can buy or sell options.

Clause 12. The method of any previous clause, wherein each standard risk block of the fixed number of standard risk blocks is priced separately.

Clause 13. The method of clause 12 or any previous clause, wherein a respective initial price of each respective standard risk block at a time of option initialization is set based on a probability distribution of the underlier, which itself is based on an implied volatility of options from a most recent expiration of a same underlier.

Clause 14. The method of clause 10 or any previous clause, further comprising: during trading, each standard risk block is dynamically priced to reflect supply and demand and a sufficiency of a liquidity pool for option payoff.

Clause 15. The method of clause 14 or any previous clause, wherein a price paid by the trader is not equal to a price of an associated standard risk block just before the trader places the trading order.

Clause 16. The method of clause 15 or any previous clause, wherein the price paid by the trader takes into account an impact of the trading order on both liquidity conditions comprising a size of a trade relative to an available liquidity in the liquidity pool and inventory conditions comprising a size and a contribution of the trade to an overall risk associated payment obligations of the liquidity pool.

Clause 17. A method of trading options, the method comprising: providing, from a smart contract to a user interface of a trader device, a tentative price based on all stakes in a set of standard risk blocks being bought, wherein the smart contract operates on a blockchain network comprising a plurality of distributed compute nodes operating a distributed consensus algorithm that determines when to record transactions on a distributed ledger across the plurality of distributed compute nodes, the transactions being recorded in an immutable manner; receiving, at a smart contract, a trading order from a trader via the user interface; converting the trading order into stakes in one or more standard risk blocks of a set of standard risk blocks; executing the trading order until an option expiration occurs at an expiration time; identifying a winning standard risk block from the set of standard risk blocks, the winning standard risk block containing a value of an underlier at the expiration time; and settling the trading order by having a liquidity pool pay a lotsize amount for each stake purchased in the winning standard risk block.

Clause 18. The method of clause 17, wherein the trading order is one of a market order and a modified limit order.

Clause 19. The method of clause 17 or clause 18, wherein funds in a liquidity pool serve as collateral for paying the lotsize amount.

Clause 20. The method of any of clauses 17-19, wherein if the winning standard risk block is within a tail of a distribution of the set of standard risk blocks, then the smart contract treats the winning standard risk block as though it was at a maximum or minimum of an expected price range associated with the distribution.

Clause 21. The method of any of clauses 17-20, wherein the lotsize amount depends on a number of stakes purchased by the trader in the winning standard risk block, which is based on a different between an original option strike and a central strike value of the winning standard risk block.

Clause 22. The method of any of clauses 17-21, wherein each standard risk block of the set of standard risk blocks comprises a width which determines a size of a potential discrepancy between the lotsize amount paid for the trading order relative to a traditional option payout.

Clause 23. The method of any of clauses 17-22, wherein the lotsize amount paid for the trading order is higher than the traditional option payout when a value of an underlier at the expiration time is higher than a block central strike value for the winning standard risk block and wherein the lotsize amount paid for the trading order is lower than the traditional option payout when the value of the underlier at the expiration time is lower than the block central strike value for the winning standard risk block.

Clause 24. A system comprising: at least one processor; and a computer-readable storage medium storing instructions which, when executed by the at least one processor, causes the at least one processor to perform operations comprising: upon an option activation via a smart contract, initializing a set of parameters, wherein the smart contract operates on a blockchain network comprising a plurality of distributed compute nodes operating a distributed consensus algorithm that determines when to record transactions on a distributed ledger across the plurality of distributed compute nodes, the transactions being recorded in an immutable manner; computing via the smart contract an expected price range for an underlier based on the set of parameters; subdividing via the smart contract the expected price range into a fixed number of standard risk blocks, wherein each respective standard risk block of the fixed number of standard risk blocks comprises a price interval centered around a specific value, wherein each standard risk block comprises a binary state dependent unit that pays at an expiration of an option lifecycle a fixed amount for a purchased stake if a reference value meets a specific condition, and nothing otherwise; and handling via the smart contract a settlement of options via payment of stakes purchased in standard risk blocks.

Clause 25. A system comprising: at least one processor; and a computer-readable storage medium storing instructions which, when executed by the at least one processor, causes the at least one processor to perform operations comprising: providing, from a smart contract to a user interface of a trader device, a tentative price based on all stakes in a set of standard risk blocks being bought, wherein the smart contract operates on a blockchain network comprising a plurality of distributed compute nodes operating a distributed consensus algorithm that determines when to record transactions on a distributed ledger across the plurality of distributed compute nodes, the transactions being recorded in an immutable manner; receiving, at a smart contract, a trading order from a trader via the user interface; converting the trading order into stakes in one or more standard risk blocks of a set of standard risk blocks; executing the trading order until an option expiration occurs at an expiration time; identifying a winning standard risk block from the set of standard risk blocks, the winning standard risk block containing a value of an underlier at the expiration time; and settling the trading order by having a liquidity pool pay a lotsize amount for each stake purchased in the winning standard risk block.

Clause 26. A system including means for performing any one or more of the steps or operations of any previous clause or as disclosed herein.

Clause 27. A non-transitory computer-readable storage device storing instructions which, when executed by one or more processors, performs any one or more steps or operations of any previous clause or as disclosed herein.

What is claimed is:

1. A method for trading options, the method comprising:
upon an option activation via a smart contract, initializing a set of parameters, wherein the smart contract operates on a blockchain network comprising a plurality of distributed compute nodes operating a distributed consensus algorithm that determines when to record transactions on a distributed ledger across the plurality of distributed compute nodes, the transactions being recorded in an immutable manner;
computing via the smart contract an expected price range for an underlier based on the set of parameters;
subdividing via the smart contract the expected price range into a fixed number of standard risk blocks, wherein each respective standard risk block of the fixed number of standard risk blocks comprises a price interval centered around a specific value, wherein each standard risk block comprises a binary state dependent unit that pays at an expiration of an option lifecycle a fixed amount for a purchased stake if a reference value meets a specific condition, and nothing otherwise; and
handling via the smart contract a settlement of options via payment of stakes purchased in standard risk blocks.

2. The method of claim 1, wherein the specific value comprises a central strike price and wherein the reference value is a value of an underlier.

3. The method of claim 2, wherein the specific condition is that the reference value be contained in the price interval of the respective standard risk block.

4. The method of claim 1, wherein the fixed number of standard risk blocks comprises 95.

5. The method of claim 1, wherein the set of parameters comprise the underlier, an activation date and an expiration date of an option, a spot value of the underlier, the expected price range for the underlier at expiration, and a number of standard deviations to be covered.

6. The method of claim 1, wherein the price interval comprises a small price interval.

7. The method of claim 1, wherein the expected price range for the underlier is computed based on a spot value of the underlier, an implied volatility of the underlier, and a number of standard deviations to be covered.

8. The method of claim 1, wherein a respective central strike price of the respective standard risk block is computed based on a spot value and an implied volatility of the underlier, a number of standard deviations to be covered, and a number of standard risk blocks in the fixed number of standard risk blocks.

9. The method of claim 1, wherein price intervals of the fixed number of standard risk blocks are computed based on a spot value and an implied volatility of the underlier, a number of standard deviations to be covered, and a number of standard risk blocks within the fixed number of standard risk blocks.

10. The method of claim 1, further comprising:
receiving, via the smart contract, a trading order from a trader, wherein the trader inputs the trading order to the smart contract via a user interface on a trader device; and
converting the trading order into an order for stakes in the fixed number of standard risk blocks.

11. The method of claim 10, wherein the user interface presents a list of all strikes at which participants can buy or sell options.

12. The method of claim 1, wherein each standard risk block of the fixed number of standard risk blocks is priced separately.

13. The method of claim 12, wherein a respective initial price of each respective standard risk block at a time of option initialization is set based on a probability distribution of the underlier, which itself is based on an implied volatility of options from a most recent expiration of a same underlier.

14. The method of claim 12, further comprising:
during trading, each standard risk block is dynamically priced to reflect supply and demand and a sufficiency of a liquidity pool for option payoff.

15. The method of claim 14, wherein a price paid by the trader is not equal to a price of an associated standard risk block just before the trader places the trading order.

16. The method of claim 15, wherein the price paid by the trader takes into account an impact of the trading order on both liquidity conditions comprising a size of a trade relative to an available liquidity in the liquidity pool and inventory conditions comprising a size and a contribution of the trade to an overall risk associated payment obligations of the liquidity pool.

17. A method of trading options, the method comprising:
providing, from a smart contract to a user interface of a trader device, a tentative price based on all stakes in a set of standard risk blocks being bought, wherein the smart contract operates on a blockchain network comprising a plurality of distributed compute nodes operating a distributed consensus algorithm that determines when to record transactions on a distributed ledger across the plurality of distributed compute nodes, the transactions being recorded in an immutable manner;
receiving, at a smart contract, a trading order from a trader via the user interface;
converting the trading order into stakes in one or more standard risk blocks of a set of standard risk blocks;
executing the trading order until an option expiration occurs at an expiration time;
identifying a winning standard risk block from the set of standard risk blocks, the winning standard risk block containing a value of an underlier at the expiration time; and
settling the trading order by having a liquidity pool pay a lotsize amount for each stake purchased in the winning standard risk block.

18. The method of claim 17, wherein the trading order is one of a market order and a modified limit order.

19. The method of claim 17, wherein funds in a liquidity pool serve as collateral for paying the lotsize amount.

20. The method of claim 17, wherein if the winning standard risk block is within a tail of a distribution of the set of standard risk blocks, then the smart contract treats the winning standard risk block as though it was at a maximum or minimum of an expected price range associated with the distribution.

21. The method of claim 17, wherein the lotsize amount depends on a number of stakes purchased by the trader in the winning standard risk block, which is based on a different between an original option strike and a central strike value of the winning standard risk block.

22. The method of claim 17, wherein each standard risk block of the set of standard risk blocks comprises a width which determines a size of a potential discrepancy between the total amount paid for the trading order relative to a traditional option payout.

23. The method of claim 22, wherein the total amount paid for the trading order is higher than the traditional option payout when a value of an underlier at the expiration time is higher than a block central strike value for the winning standard risk block and wherein the total amount paid for the trading order is lower than the traditional option payout when the value of the underlier at the expiration time is lower than the block central strike value for the winning standard risk block.
